(19) United States
(12) Patent Application Publication
(10) Pub. No.: US 2015/0160855 A1
(43) Pub. Date: Jun. 11, 2015

(54) MULTIPLE CHARACTER INPUT WITH A SINGLE SELECTION

(71) Applicant: Google Inc., Mountain View, CA (US)

(72) Inventor: Xiaojun Bi, Sunnyvale, CA (US)

(73) Assignee: Google Inc., Mountain View, CA (US)

(21) Appl. No.: 14/102,161

(22) Filed: Dec. 10, 2013

(51) Int. Cl. G06F 3/0488

(52) U.S. Cl. CPC G06F 3/04886

(57) ABSTRACT

A computing device is described that outputs a graphical keyboard for display that includes a plurality of keys. The computing device determines a first selection of one or more of the plurality of keys and responsive to determining a second selection of a particular key of the plurality of keys, the computing device determines at least one candidate word that includes a partial prefix. The partial prefix being is based at least in part on the first selection of the one or more of the plurality of keys. The computing device outputs at least one character string for display at a region of the graphical keyboard that is based on a location of the particular key. The at least one character string is a partial suffix of the at least one candidate word and the at least one candidate word includes the partial prefix and the partial suffix.

### BACKGROUND

Some computing devices (e.g., mobile phones, tablet computers, etc.) may provide, as part of a graphical user interface, a graphical keyboard for composing text using a presence-sensitive input device (e.g., a presence-sensitive display such as a touchscreen). The graphical keyboard may enable a user of the computing device to enter text (e.g., an e-mail, a text message, or a document, etc.). For instance, a presence-sensitive input device of a computing device may output a graphical (or “soft”) keyboard that enables the user to enter data by selecting (e.g., by tapping and/or swiping) keys displayed at the presence-sensitive input device.

In some examples, a computing device that provides a graphical keyboard may rely on word prediction, auto-correction, and/or suggestion techniques for determining a word based on one or more received gesture inputs. These techniques may speed up text entry and minimize spelling mistakes of in-vocabulary words (e.g., words in a dictionary). However, one or more of the techniques may have certain drawbacks. For instance, in some examples, a computing device that provides a graphical keyboard and relies on one or more of these techniques may not correctly predict, auto-correct, and/or suggest words based on input detected at the presence-sensitive input device. As such, a user may need to perform additional effort (e.g., additional input) to fix errors produced by one or more of these techniques.

### SUMMARY

In one example, the disclosure is directed to a method that includes outputting, by a computing device and for display, a graphical keyboard comprising a plurality of keys, and determining, by the computing device, a first selection of one or more of the plurality of keys. The method further includes responsive to determining a second selection of a particular key of the plurality of keys, determining, by the computing device, based at least in part on the first selection of one or more of the plurality of keys and the second selection of the particular key, at least one candidate word that includes a partial prefix, the partial prefix being based at least in part on the first selection of the one or more of the plurality of keys. The method further includes outputting, by the computing device, for display at a region of the graphical keyboard that is based on a location of the particular key, at least one character string that is a partial suffix of the at least one candidate word, wherein the at least one candidate word comprises the partial prefix and the partial suffix.

In another example, the disclosure is directed to a computing device comprising at least one processor and at least one module operable by the at least one processor to output, for display, a graphical keyboard comprising a plurality of keys, and determine a first selection of one or more of the plurality of keys. The at least one module is further operable by the at least one processor to responsive to determining a second selection of a particular key of the plurality of keys, determine, based at least in part on the first selection of one or more of the plurality of keys and the second selection of the particular key, at least one candidate word that includes a partial prefix, the partial prefix being based at least in part on the first selection of the one or more of the plurality of keys. The at least one module is further operable by the at least one processor to output, for display at a region of the graphical keyboard that is based on a location of the particular key, at least one character string that is a partial suffix of the at least one candidate word, wherein the at least one candidate word comprises the partial prefix and the partial suffix.

In another example, the disclosure is directed to a computer-readable storage medium encoded with instructions that, when executed, cause at least one processor of a computing device to output, for display, a graphical keyboard comprising a plurality of keys, and determine a first selection of one or more of the plurality of keys. The instructions, when executed, further cause the at least one processor of the computing device to responsive to determining a second selection of a particular key of the plurality of keys, determine, based at least in part on the first selection of one or more of the plurality of keys and the second selection of the particular key, at least one candidate word that includes a partial prefix, the partial prefix being based at least in part on the first selection of the one or more of the plurality of keys. The instructions, when executed, further cause the at least one processor of the computing device to output, for display at a region of the graphical keyboard that is based on a location of the particular key, at least one character string that is a partial suffix of the at least one candidate word, wherein the at least one candidate word comprises the partial prefix and the partial suffix.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device that is configured to present one or more partial suffixes of one or more candidate words, in accordance with one or more aspects of the present disclosure.

FIG. 2 is a block diagram illustrating an example computing device, in accordance with one or more aspects of the present disclosure.

FIG. 3 is a block diagram illustrating an example computing device that outputs graphical content for display at a remote device, in accordance with one or more techniques of the present disclosure.

FIGS. 4A and 4B are conceptual diagrams illustrating example graphical user interfaces for presenting one or more partial suffixes of one or more candidate words, in accordance with one or more aspects of the present disclosure.

FIGS. 5A and 5B are conceptual diagrams illustrating additional example graphical user interfaces for presenting one or more partial suffixes of one or more candidate words, in accordance with one or more aspects of the present disclosure.

FIGS. 6A through 6C are conceptual diagrams illustrating additional example graphical user interfaces for presenting one or more partial suffixes of one or more candidate words, in accordance with one or more aspects of the present disclosure.

FIG. 7 is a flowchart illustrating an example operation of the computing device, in accordance with one or more aspects of the present disclosure.

### DETAILED DESCRIPTION

In general, this disclosure is directed to techniques for presenting one or more word suffixes that complement a word prefix. The word prefix may be based on previous indications of user input detected by a computing device to select one or more keys of a graphical keyboard that the computing device outputs for display. Based on the word prefix, the computing device may output one or more selectable word suffixes for display. The word suffixes that the computing device outputs for display may be based on candidate words which include the word prefix and respective word suffixes. In some examples, responsive to receiving an indication of user input to select one of the word suffixes, the computing device may output the respective candidate word for display that comprises the word prefix and the selected word suffix.

In some examples, a computing device that outputs a graphical keyboard, for example, at a presence-sensitive input device, may receive input (e.g., tap gestures, non-tap gestures, etc.) detected at the presence-sensitive input device. In certain examples, a computing device may determine text (e.g., a character string) in response to an indication of a user detected by the computing device as the user performs one or more gestures at or near the presence-sensitive input device. In some examples, a gesture that traverses a single location of a single key presented at the presence-sensitive input device may indicate a selection of the single key and one or more gestures that traverse locations of multiple keys may indicate a selection of the multiple keys.

The techniques described in this disclosure may improve a speed at which a user can enter a word in a lexicon with a graphical keyboard. For instance, a computing device implementing techniques of the disclosure may present, at or near a location of a currently selected key of the graphical keyboard, one or more partial suffixes that the computing device has determined complement a previously entered prefix and/or will complete an entry of a word. The computing device may detect a selection of one of the partial suffixes and combine the selected partial suffix with the previously entered prefix to complete or at least partially complete the entry of the word. For instance, rather than relying on a sequential, selection of individual keys of a graphical keyboard to complete an entry of a character string or word, the techniques may enable a computing device to receive a partial entry of a word, and based on the partial entry of the word, predict one or more suffixes for completing the word.

The computing device may output one or more predicted suffixes for display as selectable elements at or near a key of the graphical keyboard that the user has selected. Responsive to detecting a selection of one of the selectable elements, the computing device may complete the entry of the word by combining the partial entry of the word (e.g., the prefix) with the selected suffix associated with the selected, selectable element. By outputting one or more suffixes based on one or more candidate words (e.g., included in a lexicon), the computing device may enable the user to provide a single user input to select a suffix that includes multiple characters to complete the word, rather than providing multiple user inputs to respectively select each remaining character of the word.

Presenting and selecting partial suffixes in this way to complete a multiple character entry of a character string or candidate word may provide a more efficient way to enter text using a graphical keyboard. The techniques may provide a way to enter text, whether using a tap or non-tap gestures, through fewer, sequential selections of individual keys because each individual key associated a suffix does not need to be selected. As such, the techniques may enable a computing device to determine text (e.g., a character string) in a shorter amount of time and based on fewer user inputs to select keys of the graphical keyboard. In addition, the techniques of the disclosure may enable the computing device to determine the text, while improving and/or maintaining the speed and ease that gesture inputs and graphical keyboards provide to the user. Therefore, the techniques described in this disclosure may reduce a quantity of inputs received by the computing device and may improve the speed with which a user can type a word at a graphical keyboard. A computing device that receives fewer inputs may perform fewer operations and as such consume less electrical power.

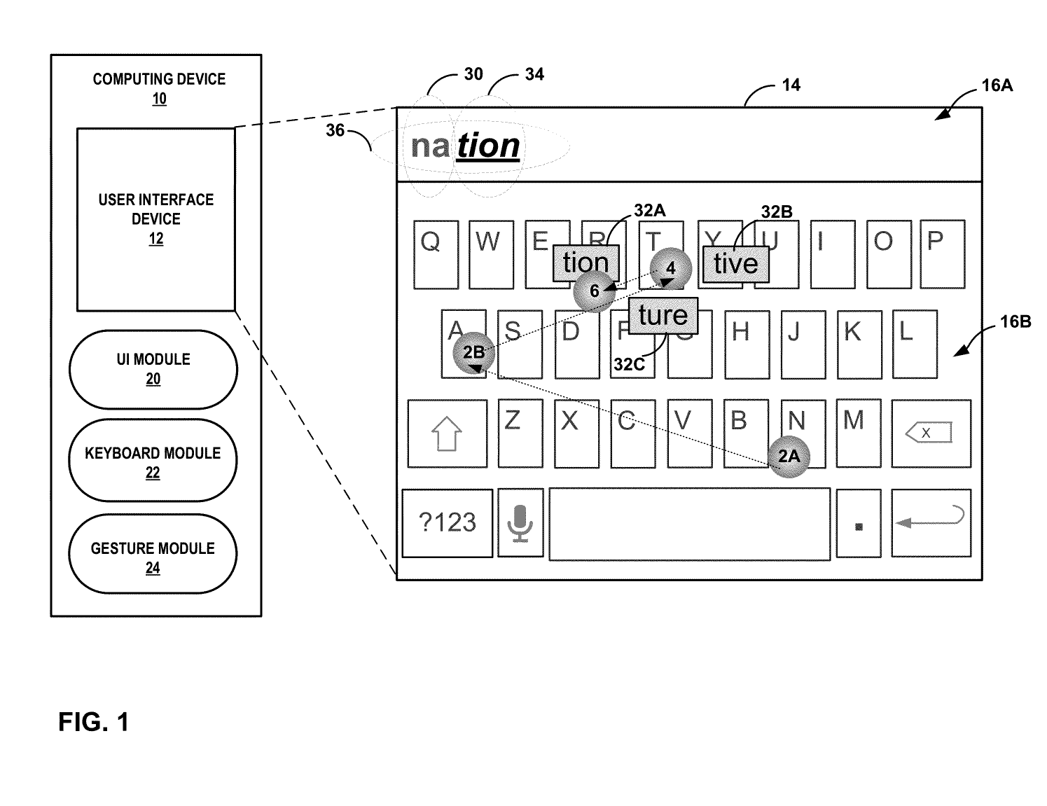

FIG. 1 is a conceptual diagram illustrating example computing device 10 that is configured to present one or more partial suffixes of one or more candidate words, in accordance with one or more aspects of the present disclosure. In the example of FIG. 1, computing device 10 may be a mobile phone. However, in other examples, computing device 10 may be a tablet computer, a personal digital assistant (PDA), a laptop computer, a portable gaming device, a portable media player, an e-book reader, a watch, television platform, or another type of computing device.

As shown in FIG. 1, computing device 10 includes a user interface device (UID) 12. UID 12 of computing device 10 may function as an input device for computing device 10 and as an output device. UID 12 may be implemented using various technologies. For instance, UID 12 may function as an input device using a presence-sensitive input device, such as a resistive touchscreen, a surface acoustic wave touchscreen, a capacitive touchscreen, a projective capacitance touchscreen, a pressure sensitive screen, an acoustic pulse recognition touchscreen, or another presence-sensitive input device technology. UID 12 may function as an output device using any one or more of a liquid crystal display (LCD), dot matrix display, light emitting diode (LED) display, organic light-emitting diode (OLED) display, e-ink, or similar monochrome or color display capable of outputting visible information to the user of computing device 10.

UID 12 of computing device 10 may include a presence-sensitive screen (e.g., presence-sensitive display) that may receive tactile user input from a user of computing device 10. UID 12 may receive indications of the tactile user input by detecting one or more tap and/or non-tap gestures from a user of computing device 10 (e.g., the user touching or pointing to one or more locations of UID 12 with a finger or a stylus pen). The presence-sensitive screen of UID 12 may present output to a user. UID 12 may present the output as a user interface (e.g., user interface 14) which may be related to functionality provided by computing device 10. For example, UID 12 may present various user interfaces of applications (e.g., an electronic message application, an Internet browser application, etc.) executing at computing device 10. A user of computing device 10 may interact with one or more of these applications to perform a function with computing device 10 through the respective user interface of each application.

Computing device 10 may include user interface (“UI”) module 20, keyboard module 22, and gesture module 24. Modules 20, 22, and 24 may perform operations described using software, hardware, firmware, or a mixture of both hardware, software, and firmware residing in and executing on computing device 10. Computing device 10 may execute modules 20, 22, and 24, with multiple processors. Computing device 10 may execute modules 20, 22, and 24 as a virtual machine executing on underlying hardware.

Gesture module 24 of computing device 10 may receive from UID 12, one or more indications of user input detected at UID 12. Generally, each time UID 12 receives an indication of user input detected at a location of UID 12, gesture module 24 may receive information about the user input from UID 12. Gesture module 24 may assemble the information received from UID 12 into a time-ordered sequence of touch events. Each touch event in the sequence may include data or components that represents parameters for characterizing a presence and/or movement (e.g., when, where, originating direction) of input at UID 12. Each touch event in the sequence may include a location component corresponding to a location of UID 12, a time component related to when UID 12 detected user input at the location, and an action component related to whether the touch event corresponds to a lift up or a push down at the location.

Gesture module 24 may determine one or more characteristics of the user input based on the sequence of touch events and include information about these one or more characteristics within each touch event in the sequence of touch events. For example, gesture module 24 may determine a start location of the user input, an end location of the user input, a density of a portion of the user input, a speed of a portion of the user input, a direction of a portion of the user input, and a curvature of a portion of the user input. One or more touch events in the sequence of touch events may include (in addition to a time, a location, and an action component as described above) a characteristic component that includes information about one or more characteristics of the user input (e.g., a density, a speed, etc.). Gesture module 24 may transmit, as output to UI module 20, the sequence of touch events including the components or parameterized data associated with each touch event.

UI module 20 may cause UID 12 to present user interface 14. User interface 14 includes graphical elements displayed at various locations of UID 12. FIG. 1 illustrates edit region 16A and graphical keyboard 16B of user interface 14. Graphical keyboard 16B includes selectable, graphical elements displayed as keys for typing text at edit region 16A. Edit region 16A may include graphical elements such as images, objects, hyperlinks, characters of text (e.g., character strings) etc., that computing device 10 generates in response to input detected at graphical keyboard 16B. In some examples, edit region 16A is associated with a messaging application, a word processing application, an internet webpage browser application, or other text entry field of an application, operating system, or platform executing at computing device 10. In other words, edit region 16A represents a final destination of the letters that a user of computing device 10 is selecting using graphical keyboard 16B and is not an intermediary region associated with graphical keyboard 16B, such as word suggestion or autocorrect region that displays one or more complete word suggestions or auto-corrections.

FIG. 1 shows the letters n-a-t-i-o-n within edit region 16A. The letters n-a-t-i-o-n make up a string of characters or candidate word 36 comprising word prefix 30 (e.g., letters n-a) and word suffix 34 (e.g., comprising letters t-i-o-n). Candidate word 36, word prefix 30, and word suffix 34 are delineated by dashed circles in the example of FIG. 1, however UI device 12 may or may not output such dashed circles in some examples.

In some examples, a word prefix may be generally described as a string of characters comprising a first portion of a word that precedes one or more characters of a suffix or an end of the word. For instance, the characters na correspond to a prefix of the words nation, national, etc. since the letters na precede the suffixes tion and tional. In some examples, a word suffix may generally be described as a string of characters comprising a second portion of a word that follows one or more characters of a prefix or the beginning of the word. For instance, the characters tion correspond to a suffix of the words nation and national since the letters tion follow the letters na. In some examples, a partial suffix may be generally described as a string of characters comprising a second portion of a word that follows one or more characters of a prefix or the word and precedes one or more characters of the end of the word. For instance, the characters tion correspond to a partial suffix of the word nationality since the letters tion follow the letters na and precede the letters ality.

A user of computing device 10 may enter text in edit region 16A by providing input (e.g., tap and/or non-tap gestures) at locations of UID 12 that display the keys of graphical keyboard 16B. In response to user input such as this, computing device 10 may output one or more characters, strings, or multi-string phrases within edit region 16A, such as candidate word 36 comprising word prefix 30 and word suffix 34.

In some examples, a word may generally be described as a string of one or more characters in a dictionary or lexicon (e.g., a set of strings with semantic meaning in a written or spoken language), a “word” may, in some examples, refer to any group of one or more characters.” For example, a word may be an out-of-vocabulary word or a string of characters not contained within a dictionary or lexicon but otherwise used in a written vocabulary to convey information from one person to another. For instance, a word may include a name, a place, slang, or any other out-of-vocabulary word or uniquely formatted strings, etc., that includes a first portion of one or more characters followed by a second portion of one or more characters.

UI module 20 may act as an intermediary between various components of computing device 10 to make determinations based on input detected by UID 12 and generate output presented by UID 12. For instance, UI module 20 may receive, as an input from keyboard module 22, a representation of a keyboard layout of the keys included in graphical keyboard 16B. UI module 20 may receive, as an input from gesture module 24, a sequence of touch events generated from information about user input detected by UID 12. UI module 20 may determine that the one or more location components in the sequence of touch events approximate a selection of one or more keys (e.g., UI module 20 may determine the location of one or more of the touch events corresponds to an area of UID 12 that presents graphical keyboard 16B). UI module 20 may transmit, as output to keyboard module 22, the sequence of touch events received from gesture module 24, along with locations where UID 12 presents each of the keys.

In response to transmitting touch events and locations of keys to keyboard module 22, UI module 20 may receive a candidate word prefix and one or more partial suffixes as suggested completions of the candidate word prefix from keyboard module 22 that keyboard module 22 determined from the sequence of touch events. UI module 20 may update user interface 14 to include the candidate word prefix from keyboard module 22 within edit region 16A and may include the one or more partial suffixes as selectable graphical elements positioned at or near a particular key of graphical keyboard 16B. UI module 20 may cause UID 12 to present the updated user interface 14 including the candidate word prefix in edit region 16A and the one or more partial word suffixes at graphical keyboard 16B.

Keyboard module 22 of computing device 10 may transmit, as output to UI module 20 (for inclusion as graphical keyboard 16B of user interface 14) a keyboard layout including a plurality of keys related to one or more written languages (e.g., English, Spanish, French, etc.). Keyboard module 22 may assign one or more characters or operations to each key of the plurality of keys in the keyboard layout. For instance, keyboard module 22 may generate a QWERTY keyboard layout including keys that represent characters used in typing the English language. The QWERTY keyboard layout may also include keys that represent operations used in typing the English language (e.g., backspace, delete, spacebar, enter, etc.).

Keyboard module 22 may receive data from UI module 20 that represents the sequence of touch events generated by gesture module 24 as well as the locations of UID 12 where UID 12 presents each of the keys of graphical keyboard 16B. Keyboard module 22 may determine, based on the locations of the keys, that the sequence of touch events represents a selection of one or more keys. Keyboard module 22 may determine a character string based on the selection where each character in the character string corresponds to at least one key in the selection. Keyboard module 22 may send data indicating the character string to UI module 20 for inclusion in edit region 16A of user interface 14.

Keyboard module 22 may include a spatial model to determine whether or not a sequence of touch events represents a selection of one or more keys. In general, a spatial model may generate one or more probabilities that a particular key of a graphical keyboard has been selected based on location data associated with a user input. In some examples, a spatial model includes a bivariate Gaussian model for a particular key. The bivariate Gaussian model for a key may include a distribution of coordinates (e.g., (x, y) coordinate pairs) that correspond to locations of UID 12 that present the given key. More specifically, in some examples, a bivariate Gaussian model for a key may include a distribution of coordinates that correspond to locations of UID 12 that are most frequently selected by a user when the user intends to select the given key. A shorter distance between location data of a user input and a higher density area of the spatial model, the higher the probability that the key associated with the spatial model has been selected. A greater distance between location data of a user input and a higher density area of the spatial model, the lower the probability that the key associated with the spatial model has been selected.

The spatial model of keyboard module 22 may compare the location components (e.g., coordinates) of one or more touch events in the sequence of touch events to respective locations of one or more keys of graphical keyboard 16B and generate a probability based on these comparisons that a selection of a key occurred. For example, the spatial model of keyboard module 22 may compare the location component of each touch event in the sequence of touch events to a key location of a particular key of graphical keyboard 16B. The location component of each touch event in the sequence may include one location of UID 12 and a key location (e.g., a centroid of a key) of a key in graphical keyboard 16B may include a different location of UID 12. The spatial model of keyboard module 22 may determine a Euclidian distance between the two locations and generate a probability based on the Euclidian distance that the key was selected. The spatial model of keyboard module 22 may correlate a higher probability to a key that shares a smaller Euclidian distance with one or more touch events than a key that shares a greater Euclidian distance with one or more touch events. Based on the spatial model probability associated with each key, keyboard module 22 may assemble the individual key selections with the highest spatial model probabilities into a time-ordered sequence of keys that keyboard module 22 may then determine represents a character string.

Keyboard module 22 may access a lexicon of computing device 10 to autocorrect (e.g., spellcheck) a character string generated from a sequence of key selections before and/or after outputting the character string to UI module 20 for inclusion within edit region 16A of user interface 14. The lexicon is described in more detail below. In summary, the lexicon of computing device 10 may include a list of words within a written language vocabulary. Keyboard module 22 may perform a lookup in the lexicon of a character string generated from a selection of keys to identify one or more candidate words that include at least some or all of the characters of the character string generated based on the selection of keys.

For example, keyboard module 22 may determine that a selection of keys corresponds to a sequence of letters that make up the character string n-a-t-o-i-n. Keyboard module 22 may compare the string n-a-t-o-i-n to one or more words in the lexicon. In some examples, techniques of this disclosure may use a Jaccard similarity coefficient that indicates a degree of similarity between a character string inputted by a user and a word in the lexicon. In general, a Jaccard similarity coefficient, also known as a Jaccard index, represents a measurement of similarity between two sample sets (e.g., a character string and a word in a dictionary). Based on the comparison, keyboard module 22 may generate a Jaccard similarity coefficient for one or more words in the lexicon. Each candidate word may include, as a prefix, an alternative arrangement of some or all of the characters in the character string. In other words, each candidate word may include as the first letters of the word, the letters of the character string determined from the selection of keys. For example, based on a selection of n-a-t-o-i-n, keyboard module 22 may determine that a candidate word of the lexicon with a greatest Jaccard similarity coefficient to n-a-t-o-i-n is nation. Keyboard module 22 may output the autocorrected character string n-a-t-i-o-n to UI module 20 for inclusion in edit region 16A rather than the actual character string n-a-t-o-i-n indicated by the selection of keys.

In some examples, each candidate word in the lexicon may include a candidate word probability that indicates a frequency of use in a language and/or a likelihood that a user input at UID 12 (e.g., a selection of keys) actually represents an input to select the characters or letters associated with that particular candidate word. In other words, the one or more candidate words may each have a frequency of use probability that indicates how often each word is used in a particular written and/or spoken human language. Keyboard module 22 may distinguish two or more candidate words that each have high Jaccard similarity coefficients based on the frequency of use probability. Said differently, if two or more candidate words both have a high Jaccard similarity coefficient indicating that each could equally be the correct spelling of a character string, keyboard module 22 may select the candidate word with the highest frequency of use probability as being the most likely candidate word based on the selection of keys.

To reduce a quantity of individual key selections performed by a user when inputting a word in a lexicon using graphical keyboard 16B, and to potentially speed up word input using graphical keyboard 16B, keyboard module 22 may further utilize the lexicon to predict one or more partial suffixes that may complete the entry of a particular word in the lexicon. Keyboard module 22 may output the one or more predicted suffixes as selectable elements at graphical keyboard 16B. Rather than require the user to tap, gesture, or otherwise select the individual key and letter combinations required to type the remaining letters of the candidate word (e.g., in some instances, the word suffix), the user may type or select letters of a partial prefix of the word, and then, select one of the predicted partial suffixes that complements the partial prefix and completes the entry of the candidate word.

In other words, rather than require a user to individually, sequentially select each and every key and letter combination of a particular candidate word, keyboard module 22 may determine that a first selection of keys are for selecting a prefix of letters of a candidate word and based on the prefix, keyboard module 22 may determine one or more partial suffixes of letters that may complete the word. Keyboard module 22 may cause UI module 20 to present the one or more partial suffixes as selectable elements at or near a selected key of graphical keyboard 16B. For example, UI module 20 may present an individual text box corresponding to each individual suffix around the location of a selected key. Each text box represents a selectable graphical element for a user to provide input at UID 12 to choose a corresponding suffix. In other words, as described below, computing device 10 may determine that an input detected at UID 12 at a location at which one of the selectable elements is being presented corresponds to a selection of that selectable element and that corresponding partial suffix. Responsive to detecting a selection of one of the one or more selectable elements, keyboard module 22 may cause UI module 20 to output the particular candidate word, comprising both the letters of the prefix that was entered via sequential, individual key selections, and the letters of the selected suffix, at edit region 16A.

The techniques are now further described in detail with reference to FIG. 1. In the example of FIG. 1, computing device 10 outputs for display graphical keyboard 16B comprising a plurality of keys. For example, keyboard module 22 may generate data that includes a representation of graphical keyboard 16B. UI module 20 may generate user interface 14 and include graphical keyboard 16B in user interface 14 based on the data representing graphical keyboard 16B. UI module 20 may send information to UID 12 that includes instructions for displaying user interface 14 at UID 12. UID 12 may receive the information and cause UID 12 to present user interface 14 including edit region 16A, graphical keyboard 16B, and suggested word region 16C. Graphical keyboard 16B may include a plurality of keys.

Computing device 10 may determine a first selection of one or more of the plurality of keys. For example, as UID 12 presents user interface 14, a user may provide gesture 2A followed by gesture 2B (collectively, “gestures 2”) at locations of UID 12 where UID 12 presents graphical keyboard 16B. FIG. 1 shows gesture 2A being performed as a tap gesture at an <N-key> of graphical keyboard 16B prior to gesture 2B being performed as a subsequent tap gesture at an <A-key>.

Gesture module 24 may receive information indicating gestures 2A and 2B from UID 12 and assemble the information into a time-ordered sequence of touch events (e.g., each touch event including a location component, a time component, and an action component). Gesture module 24 may output the sequence of touch-events of gestures 2A and 2B to UI module 20 and keyboard module 22. UI module 20 may determine that location components of each touch event in the sequence correspond to an area of UID 12 that presents graphical keyboard 16B and determine that UID 12 received an indication of a selection of one or more of the plurality of keys of graphical keyboard 16B. UI module 20 may transmit the sequence of touch events to keyboard module 22 along with locations where UID 12 presents each of the keys of graphical keyboard 16B. Keyboard module 22 may interpret the touch events associated with gestures 2A and 2B and determine a selection of individual keys of graphical keyboard 16B based on the sequence of touch events and the key locations from UI module 20.

Keyboard module 22 may compare the location component of each touch event in the sequence of touch events to each key location to determine one or more keys that share the same approximate locations of UID 12 as the locations of touch events in the sequence of touch events. For example, using a spatial model, keyboard module 22 may determine a Euclidian distance between the location components of one or more touch events and the location of each key. Based on these Euclidian distances, and for each key, keyboard module 22 may determine a spatial model probability that the one or more touch events corresponds to a selection of the key. Keyboard module 22 may include each key with a non-zero spatial model probability (e.g., a key with a greater than zero percent likelihood that gestures 2A and 2B represent selections of the keys) in a sequence of keys. In the example of FIG. 1, keyboard module 22 may determine a non-zero spatial model probability associated with each key at or near gesture 2A and determine a non-zero spatial model probability associated with each key at or near gesture 2B and generate an ordered sequence of keys including the <N-key> and <A-key>. Keyboard module 22 may determine a character string n-a based on the selection of the <N-key> and <A-key> and cause UI module 20 to output the character string n-a as word prefix 30 within edit region 16A of user interface 14.

Computing device 10 may determine a second selection of a particular key of the plurality of keys of graphical keyboard 16B. For example, the user may provide gesture 4 at a location of UID 12 where UID 12 presents graphical keyboard 16B. FIG. 1 shows gesture 4 being performed at a <T-key> of graphical keyboard 16B, subsequent to the user performing gestures 2A and 2B at the <N-key> and <A-key>. Gesture module 24 may receive information indicating gesture 4 from UID 12, assemble the information into a time-ordered sequence of touch events, and output the sequence of touch-events of gesture 4 to UI module 20 and keyboard module 22. UI module 20 and keyboard module 22 may determine that the touch events associated with gesture 4 represent an indication of a second selection of one or more keys of graphical keyboard 16B, in particular, keyboard module 22 may interpret the touch events associated with gesture 4 as a selection of the <T-key>. Keyboard module 22 may cause UI module 22 to output the letter t as the first letter of word suffix 34, following word prefix 30, within edit region 16A.

Responsive to determining a second selection of a particular key of the plurality of keys (e.g., gesture 4), computing device 10 may determine, based at least in part on the first selection of one or more of the plurality of keys (e.g., gestures 2A and 2B) and the second selection of the particular key, at least one candidate word that includes a partial prefix. The partial prefix may be based at least in part on the first selection of the one or more of the plurality of keys.

For example, keyboard module 22 may determine whether any of the words in the lexicon begin with word prefix 30 (e.g., a prefix comprising the letters n-a generated by the selection of the <N-key> and <A-key> from gestures 2A and 2B) and end with a suffix that begins with the letter t (based on gesture 4). Keyboard module 22 may perform a look up and identify one or more candidate words from the lexicon that begin with the letters n-a-t. For instance, keyboard module 22 may identify the candidate words nation, national, nationalism, nationalist, nationality, native, natural, nature, naturopathy, etc. as some example candidate words in a lexicon that begin with the letters n-a-t. Keyboard module 22 may determine the one or more candidate words from the lexicon that have a highest frequency of use in a language. That is, keyboard module 22 may determine which of the one or more candidate words have a greatest likelihood of being the word that a user intended to enter at edit region 16A with a selection of keys based on gestures 2A, 2B, and 4.

For example, for each of the candidate words candidate words nation, national, nationalism, nationalist, nationality, native, natural, nature, naturopathy, etc., keyboard module 22 may determine a probability that indicates how frequently each candidate word is written and/or spoken in a communication based on the particular language of the lexicon. In some examples, the probability may further be based on a previous input context that includes one or more previously inputted characters or strings. Keyboard module 22 may determine which candidate word or words have the highest probability or highest frequency of use as being the most likely candidate words being inputted with keyboard 16B. In the example of FIG. 1, keyboard module 22 may determine that the candidate words nation, nature, and native are the highest probability candidate words that begin with the letters n-a-t.

Computing device 10 may output at least one character string that is a partial suffix of the at least one candidate word, for display, at a region of graphical keyboard 16B that is based on a location of the particular key associated with the second selection (e.g., gesture 4). The at least one candidate word comprises the partial prefix and the partial suffix. For instance, after keyboard module 22 determines one or more candidate words with a high frequency of use, and rather than require a user to finish typing any of the candidate words, keyboard module 22 may cause UI module 20 to present one or more selectable elements associated with each high frequency candidate word.

Each of the one or more selectable elements may correspond to a portion of each candidate word that follows or succeeds the portion of the corresponding candidate word that includes the letters or characters associated with prefix 30 (e.g., the first selection of keys). In other words, each of the selectable elements may corresponds to a complete or partial suffix associated with a corresponding candidate word made up of the latter part of a candidate word that follows prefix 30.

A user can select one selectable element to complete entry of one of the candidate words with the associated suffix by providing a user input at a location of UID 12 that output the selectable element. That is, keyboard module 22 may cause UI module 20 to present selectable elements 32A-32C (collectively, “selectable elements 32”). Each of selectable elements 32 is associate with one of the partial suffixes of the highest candidate words (e.g., nation, nature, and native) that begin with word prefix 30 (e.g., n-a) and the last selected key/letter (e.g., s) associated with gesture 4. A user may select one of selectable elements 32 to complete entry of a character string in edit region 16A with the partial suffix associated with the selected on of selectable elements 32.

Keyboard module 22 may cause UI module 20 to present the one or more partial suffixes as selectable elements 32 at or near a selected key of graphical keyboard 16B. For example, UI module 20 may present an individual text box corresponding to each individual suffix around the location of a selected key. Each text box represents one of selectable graphical elements 32 from which a user can provide input at UID 12 to choose a corresponding suffix. Each text box may overlap a portion of an adjacent, non-selected key. In other words, as shown in FIG. 1, selectable elements 32 are overlaid in front-of or on-top-of the <E-key>, <R-key>, <F-key>, <G-key>, <Y-key>, and <U-key>. Said differently, selectable elements 32 are overlaid onto the region of UID 12 at which UID 12 presents the one or more keys of graphical keyboard 16B that are adjacent to the selected <T-key>.

Responsive to determining a third selection of the at least one character string that is the partial suffix, UID 12 may output for display, the candidate word. In other words, UI module 20 may receive a sequence of touch events that indicate gesture 6 was detected at UID 12 and sent the sequence of touch events associated with gesture 6 to keyboard module 22 along with a location of each of selectable elements 32. Keyboard module 22 may determine that selectable element 32, and the suffix t-i-o-n was selected. Keyboard module 22 may determine that a user selected the candidate word nation based on the selection of suffix t-i-o-n and output candidate word 36 comprising prefix 30 and suffix 34 to UI module 20 for inclusion within edit region 16A.

In this way, the techniques of the disclosure may enable a computing device to determine a character string, such as candidate word 36, in a shorter amount of time and based on fewer inputs to select keys of a graphical keyboard, such as graphical keyboard 16B. In addition, the techniques may enable the computing device to determine the character string, while improving and/or maintaining the speed and ease that gesture inputs and graphical keyboards provide to the user. Therefore, the techniques described in this disclosure may improve the speed with which a user can type a word at a graphical keyboard. As such, the computing device may receive fewer inputs from a user to enter text using a graphical keyboard. A computing device that receives fewer inputs may perform fewer operations and as such consume less electrical power.

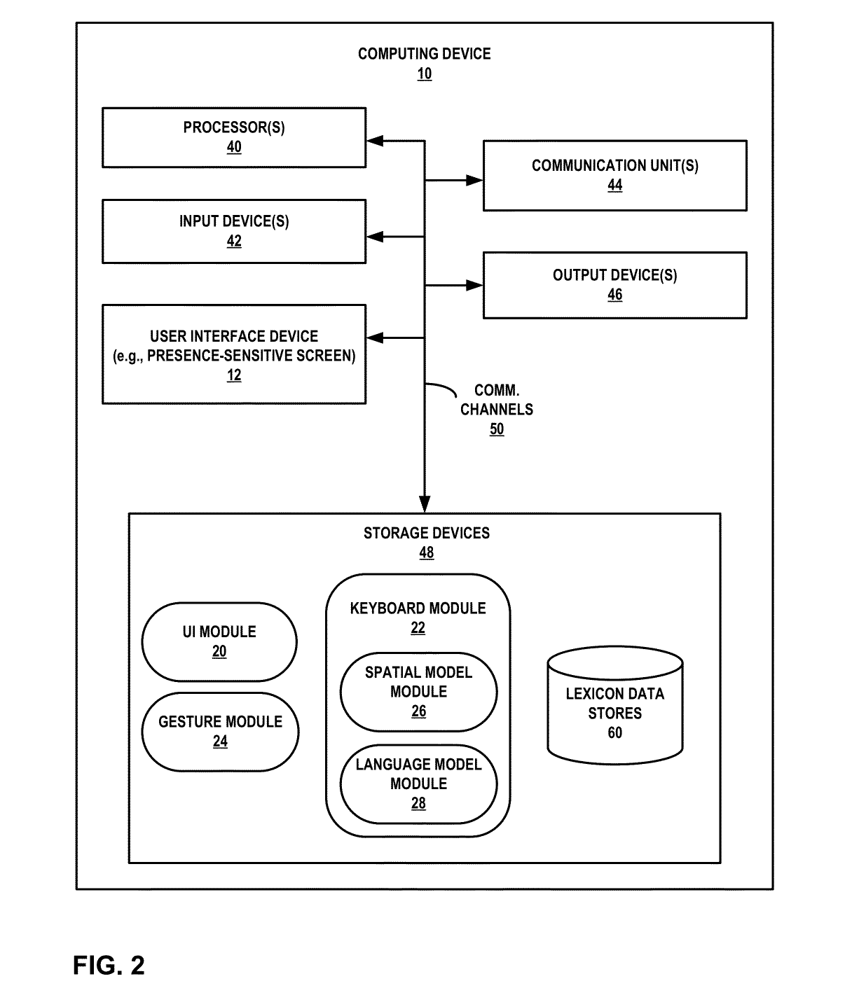

FIG. 2 is a block diagram illustrating an example computing device, in accordance with one or more aspects of the present disclosure. Computing device 10 of FIG. 2 is described below within the context of FIG. 1. FIG. 2 illustrates only one particular example of computing device 10, and many other examples of computing device 10 may be used in other instances and may include a subset of the components included in example computing device 10 or may include additional components not shown in FIG. 2.

As shown in the example of FIG. 2, computing device 10 includes user interface device 12 (“UID 12”), one or more processors 40, one or more input devices 42, one or more communication units 44, one or more output devices 46, and one or more storage devices 48. Storage devices 48 of computing device 10 also include UI module 20, keyboard module 22, gesture module 24, and lexicon data stores 60. Keyboard module 22 includes spatial model module 26 (“SM module 26”) and language model module 28 (“LM module 28”). Communication channels 50 may interconnect each of the components 12, 13, 20, 22, 24, 26, 28, 40, 42, 44, 46, and 60 for inter-component communications (physically, communicatively, and/or operatively). In some examples, communication channels 50 may include a system bus, a network connection, an inter-process communication data structure, or any other method for communicating data.

One or more input devices 42 of computing device 10 may receive input. Examples of input are tactile, audio, and video input. Input devices 42 of computing device 10, in one example, includes a presence-sensitive input device (e.g., a touch sensitive screen, a presence-sensitive display), mouse, keyboard, voice responsive system, video camera, microphone or any other type of device for detecting input from a human or machine.

One or more output devices 46 of computing device 10 may generate output. Examples of output are tactile, audio, and video output. Output devices 46 of computing device 10, in one example, includes a presence-sensitive display, sound card, video graphics adapter card, speaker, cathode ray tube (CRT) monitor, liquid crystal display (LCD), or any other type of device for generating output to a human or machine.

One or more communication units 44 of computing device 10 may communicate with external devices via one or more networks by transmitting and/or receiving network signals on the one or more networks. For example, computing device 10 may use communication unit 44 to transmit and/or receive radio signals on a radio network such as a cellular radio network. Likewise, communication units 44 may transmit and/or receive satellite signals on a satellite network such as a GPS network. Examples of communication unit 44 include a network interface card (e.g. such as an Ethernet card), an optical transceiver, a radio frequency transceiver, a GPS receiver, or any other type of device that can send and/or receive information. Other examples of communication units 44 may include Bluetooth®, GPS, 3G, 4G, and Wi-Fi® radios found in mobile devices as well as Universal Serial Bus (USB) controllers.

In some examples, UID 12 of computing device 10 may include functionality of input devices 42 and/or output devices 46. In the example of FIG. 2, UID 12 may be or may include a presence-sensitive input device. In some examples, a presence-sensitive input device may detect an object at and/or near the presence-sensitive input device. As one example range, a presence-sensitive input device may detect an object, such as a finger or stylus that is within two inches or less of the presence-sensitive input device. The presence-sensitive input device may determine a location (e.g., an (x,y) coordinate) of the presence-sensitive input device at which the object was detected. In another example range, a presence-sensitive input device may detect an object six inches or less from the presence-sensitive input device and other ranges are also possible. The presence-sensitive input device may determine the location of the input device selected by a user's finger using capacitive, inductive, and/or optical recognition techniques. In some examples, presence-sensitive input device provides output to a user using tactile, audio, or video stimuli as described with respect to output device 46. In the example of FIG. 2, UID 12 presents a user interface (such as user interface 14 of FIG. 1) at UID 12.

While illustrated as an internal component of computing device 10, UID 12 also represents and external component that shares a data path with computing device 10 for transmitting and/or receiving input and output. For instance, in one example, UID 12 represents a built-in component of computing device 10 located within and physically connected to the external packaging of computing device 10 (e.g., a screen on a mobile phone). In another example, UID 12 represents an external component of computing device 10 located outside and physically separated from the packaging of computing device 10 (e.g., a monitor, a projector, etc. that shares a wired and/or wireless data path with a tablet computer).

One or more storage devices 48 within computing device 10 may store information for processing during operation of computing device 10 (e.g., lexicon data stores 60 of computing device 10 may store data related to one or more written languages, such as prefixes and suffixes of words and common pairings of words in phrases, accessed by LM module 28 during execution at computing device 10). In some examples, storage device 48 is a temporary memory, meaning that a primary purpose of storage device 48 is not long-term storage. Storage devices 48 on computing device 10 may configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 48, in some examples, also include one or more computer-readable storage media. Storage devices 48 may be configured to store larger amounts of information than volatile memory. Storage devices 48 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 48 may store program instructions and/or data associated with UI module 20, keyboard module 22, gesture module 24, SM module 26, LM module 28, and lexicon data stores 60.

One or more processors 40 may implement functionality and/or execute instructions within computing device 10. For example, processors 40 on computing device 10 may receive and execute instructions stored by storage devices 48 that execute the functionality of UI module 20, keyboard module 22, gesture module 24, SM module 26, and LM module 28. These instructions executed by processors 40 may cause computing device 10 to store information, within storage devices 48 during program execution. Processors 40 may execute instructions of modules 20-28 to cause UID 12 to display user interface 14 at UID 12. That is, modules 20-28 may be operable by processors 40 to perform various actions, including receiving an indication of a gesture at locations of UID 12 and causing UID 12 to present user interface 14 at UID 12.

In accordance with aspects of this disclosure computing device 10 of FIG. 2 may output for display at UID 12 a graphical keyboard comprising a plurality of keys. For example during operational use of computing device 10, keyboard module 22 may cause UI module 20 of computing device 10 to output a keyboard layout (e.g., an English language QWERT keyboard, etc.) for display at UID 12. UI module 20 may receive data specifying the keyboard layout from keyboard module 22 over communication channels 50. UI module 20 may use the data to generate user interface 14 including edit region 16A and the plurality of keys of the keyboard layout from keyboard module 22 as graphical keyboard 16B. UI module 20 may transmit data over communication channels 50 to cause UID 12 to present user interface 14 at UID 12. UID 12 may receive the data from UI module 20 and cause UID 12 to present user interface 14.

Computing device 10 may determine a first selection of one or more of the plurality of keys. For example, a user may provide gesture 2A followed by gesture 2B at locations of UID 12 where UID 12 presents graphical keyboard 16B. UID 12 may receive gestures 2 detected at UID 12 and send information about gestures 2 over communication channels 50 to gesture module 24.

UID 12 may virtually overlay a grid of coordinates onto UID 12. The grid may not be visibly displayed by UID 12. The grid may assign a coordinate that includes a horizontal component (X) and a vertical component (Y) to each location. Each time UID 12 detects a gesture input, such as gestures 2, gesture module 24 may receive information from UID 12. The information may include one or more coordinate locations and associated times indicating to gesture module 24 both, where UID 12 detects the gesture input at UID 12, and when UID 12 detects the gesture input.

Gesture module 24 may receive information across communication channel 50 from UID 12 indicating gestures 2A and 2B and assemble the information into a time-ordered sequence of touch events. For example, each touch event in the sequence of touch events may comprise a time that indicates when the input at UID 12 is received, a coordinate of a location at UID 12 where the input at UID 12 is received, and/or an action component associated with the input at UID 12. The action component may indicate whether the touch event corresponds to a push down at UID 12 or a lift up at UID 12.

In some examples, gesture module 24 may determine one or more characteristics of tap or non-tap gesture input detected at UID 12 and may include the characteristic information as a characteristic component of each touch event in the sequence. For instance, gesture module 24 may determine a speed, a direction, a density, and/or a curvature of one or more portions of tap or non-tap gesture input detected at UID 12. For example, gesture module 24 may determine the speed of an input at UID 12 by determining a ratio between a distance between the location components of two or more touch events in the sequence and a difference in time between the two or more touch events in the sequence. Gesture module 24 may determine a direction of an input at UID 12 by determining whether the location components of two or more touch events in the sequence represent a direction of movement across UID 12. For instance, gesture module 24 may determine a difference between the (x,y) coordinate values of two location components of and based on the difference, assign a direction (e.g., left, right, up, down, etc.) to a portion of an input at UID 12. In one example, a negative difference in x coordinates may correspond to a right-to-left direction of an input at UID 12 and a positive difference in x coordinates may represent a left-to-right direction of an input at UID 12. Similarly, a negative difference in y coordinates may correspond to a bottom-to-top direction of an input at UID 12 and positive difference in y coordinates may represent a top-to-bottom direction of an input at UID 12.

Gesture module 24 may output the time ordered sequence of touch events, in some instances including one or more characteristic components, to UI module 20 for interpretation of the input at UID 12 relative to the user interface (e.g., user interface 14) presented at UID 12. UI module 20 may receive the touch events over communication channels 50 and determine that location components of the touch events correspond to an area of UID 12 that presents graphical keyboard 16B. UI module 20 may transmit the sequence of touch events to keyboard module 22 along with locations where UID 12 presents each of the keys of graphical keyboard 16B.

Keyboard module 22 may interpret the touch events associated with gestures 2A and 2B and determine a selection of individual keys of graphical keyboard 16B based on the sequence of touch events and the key locations from UI module 20. Keyboard module 22 may compare the location component of each touch event in the sequence of touch events to each key location to determine one or more keys that share the same approximate locations of UID 12 as the locations of touch events in the sequence of touch events.

For example, SM module 26 of keyboard module 22 may determine a Euclidian distance between the location components of one or more touch events and the location of each key. Based on these Euclidian distances, and for each key, keyboard module 22 may determine a spatial model probability that the one or more touch events corresponds to a selection of the key. In other words, SM module 26 may compare the location components of each touch event in the sequence of touch events to each key location, and for each key, generate a spatial model probability that a selection of the key occurred. The location components of one or more touch events in the sequence may include one or more locations of UID 12. A key location (e.g., a centroid of a key) may include a different location of UID 12. SM module 26 may determine a probability that one or more touch events in the sequence correspond to a selection of a key based on a Euclidian distance between the key location and the one or more touch event locations. SM module 26 may correlate a higher probability to a key that shares a smaller Euclidian distance with location components of the one or more touch events than a key that shares a greater Euclidian distance with location components of the one or more touch events (e.g., the probability of a key selection may exceed ninety nine percent when a key shares a near zero Euclidian distance to a location component of one or more touch events and the probability of the key selection may decrease proportionately with an increase in the Euclidian distance).

Based on the spatial model probability associated with each key, keyboard module 22 may assemble the individual key selections with the highest spatial model probabilities into a time-ordered sequence of keys. Keyboard module 22 may include each key with a non-zero spatial model probability (e.g., a key with a greater than zero percent likelihood that tap gestures 2A and 2B represent selections of the keys) in a sequence of keys.

Keyboard module 22 may associate the location component, the time component, the action component and the characteristic component of one or more touch events in the sequence of touch events with a corresponding key in the sequence. If more than one touch event corresponds to a key, keyboard module 22 may combine (e.g., average) similar components of the multiple touch events into a single corresponding component, for instance, a single characteristic component that includes information about an input at UID 12 to select the key. In other words, each key in the sequence of keys may inherit the information about the characteristics of the gestures or input at UID 12 associated with the one or more corresponding touch events from which the key was derived.

SM module 26 of keyboard module 22 may determine a non-zero spatial model probability associated with each key at or near gesture 2A and gesture 2B and generate an ordered sequence of keys including the <N-key> and <A-key>. Keyboard module 22 may determine a character string n-a based on the selection of the <N-key> and <A-key> and output data to UI module 20 associated with the sequence of keys to cause UI module 20 to output the character string n-a as word prefix 30 within edit region 16A of user interface 14.

Carrying over the example of FIG. 1, subsequent to providing gestures 2 at graphical keyboard 16B, the user of computing device 10 may provide gesture 4 at a location of UID 12 at which the <T-key> of graphical keyboard 16B is being displayed UID 12. Gesture module 24 may output a sequence of touch events associated with gesture 4 to UI module 20. Responsive to determining that the sequence of touch events associated with gesture 4 represents a selection of one or more keys of graphical keyboard 16B, UI module 20 may output the sequence of touch events associated with gesture 4 to keyboard module 22 for further interpretation by SM module 26. SM module 26 of keyboard module 22 may determine a non-zero spatial model probability that the sequence of touch events represents a selection of the <T-key> of graphical keyboard 16B. Keyboard module 22 may determine that the letter t is a selected character based on the determined selection of the <T-key>.

To improve a speed and efficiency at which computing device 10 can receive input associated with text at graphical keyboard 16B, computing device 10 may present selectable elements 32 at locations of UID 12 after receiving gesture 4 to select the character t. Each of selectable elements 32 corresponds to a complete or partial suffix of a candidate word that begins with the characters of prefix 30 and the last selected character (e.g., the letter t). A user of computing device 10 can choose one of selectable elements 32 by providing input at or near a location of UID 12 at which one of selectable elements 32 is displayed.

Computing device 10 may determine a selection of one of selectable elements 32 based on input at or near a location of UID 12 at which one of selectable elements 32 is displayed. Based on the selection of one of selectable elements 32, computing device 10 may determine a corresponding, multiple character suffix that begins with the selected character. Computing device 10 may automatically input the characters associated with the multiple character suffix of the selected one of selectable elements 32 within edit region 16A. Computing device 10 may cause the character of the multiple character suffix to follow or succeed the characters of prefix 30 within edit region 16A such that the characters within edit region 16A form or define at least a portion of a candidate word. In this way, rather than require a slow and inefficient selection of multiple individual keys of graphical keyboard 16B to type the multiple character suffix associated with the selected one of selectable elements 32, computing device 10 can quickly and efficiently input an entire multiple character suffix into edit region 16A based on only a single input to select one of selectable elements 32.

For example, responsive to determining a selection of the <T-key> based on gesture 4, LM module 28 of keyboard module 22 may determine at least one candidate word comprising prefix 30 and the selected character t. For example, to determine which multiple character suffixes to present as one or more corresponding selectable elements 32, keyboard module 22 may first determine one or more candidate words that begin with the letters of prefix 30 and the selected character t. LM module 28 of keyboard module 22 may perform a look up within lexicon data stores 60 to identify one or more candidate words stored at lexicon data stores 60 that begin with the letters n-a-t. LM module 28 may identify the candidate words nation, national, nationalism, nationalist, nationality, native, natural, nature, naturopathy, etc. as some example candidate words in lexicon data stores 60 that begin with the letters n-a-t.

LM module 28 of keyboard module 22 may determine the one or more candidate words from lexicon data stores 60 that have a highest probability of being the candidate words that a user may wish to enter by providing input at graphical keyboard 16B. The probability may indicate a frequency of use of each candidate word in a language context. That is, LM module 28 may determine that one or more candidate words that have a greatest likelihood of being the word that a user may wish to enter at edit region 16A are the one or more candidate words that appear most often during an instance of written and/or spoken communication using a particular language.

In some examples, a “candidate word” determined from lexicon data stores 60 may comprise a phrase or multiple words. For instance, while LM module 28 may identify one of the candidate words that begin with the letters n-a-t as being the word national, in some examples, LM module 28 may determine that the phrase national anthem or national holiday are also each individual “candidate words” that begin with the letters n-a-t. Said differently, the techniques described in this disclosure are applicable to candidate word prediction and phrase prediction comprising multiple candidate words. For every instance in which a computing device determines a “candidate word” the computing device may be determine a candidate word that comprises a candidate phrase made of two or more words.

LM module 28 of keyboard module 22 may determine a probability associated with each candidate word that includes prefix 30 and the selected character t. Responsive to determining that the probability of associated with a candidate word satisfies a threshold, keyboard module 22 may determine that a suffix associated with the candidate word is worth outputting for display as one of selectable elements 32. In other words, if keyboard module 22 determines that the probability associated with a candidate word does not satisfy a threshold (e.g., fifty percent), keyboard module 22 may not cause UI module 20 and UID 12 to present a suffix associated with the candidate word as one of selectable elements 32. If however keyboard module 22 determines that the probability associated with the candidate word does satisfy the threshold, keyboard module 22 may cause UI module 20 and UID 12 to present a suffix associated with the candidate word as one of selectable elements 32.

For example, for each of the candidate words candidate words nation, national, nationalism, nationalist, nationality, native, natural, nature, naturopathy, etc., LM module 28 may determine a probability that indicates how frequently each candidate word is written and/or spoken in a communication based on the particular language of the lexicon. If a large quantity of frequently used candidate words is identified (e.g., more than ten), LM module 28 may determine which candidate word or words that have the highest probability or highest frequency of use amongst the other candidate words as being the most likely candidate words being inputted with keyboard 16B. In the example of FIG. 1, LM module 28 may determine that the candidate words nation, nature, and native are the highest probability candidate words stored at lexicon data stores 60 that begin with the letters n-a-t and also have a probability that satisfies a threshold (e.g., fifty percent).

In some examples, LM module 28 may utilize an n-gram language model to determine a probability associated with each candidate word that includes prefix 30 and the selected character t. LM module 28 may use the n-gram language model to determine a probability that each candidate word appears in a sequence of words including the candidate word. LM module 28 may determine the probability of each candidate word appearing subsequent to or following one or more words entered at edit region 16A just prior to the detection of gestures 2 and 4 by computing device 10.

For instance, LM module 28 may determine one or more words entered within edit region 16A prior to receiving gestures 2 and 4 and determine, based on the one or more previous words, a probability that gesture 2 and 4 are associated with a selection of keys for entering each candidate word. LM module 28 may determine the previous word one was entered prior to detecting gesture 2 and 4 and assign a high probability to the candidate word nation since LM module 28 may determine that the phrase one nation is a common phrase. LM module 28 may determine the previous words what is your were entered prior to detecting gestures 2 and 4 and determine that the word nationality has a high probability of being the word associated with gestures 2 and 4 after determining the phrase what is your nationality is more likely than the phrase what is your nation.

After identifying the most probable candidate words that complement prefix 30 based on a frequency of use probability and/or an n-gram language model probability, keyboard module 22 may generate one or more partial or complete suffixes for which to provide as selectable elements 32 within user interface 14. Keyboard module 22 may determine a single suffix associated with each of the highest probability candidate words by removing the initial characters from each candidate word that correspond to prefix 30. In other words, keyboard module 22 may subtract or remove prefix 30 from each of the highest probability candidate words, and determine that a suffix associated with each of elements 32 corresponds to the remaining characters of each of the highest probability words after removing prefix 30.

For example, LM module 28 may determine that the candidate words nation, nature, and native are the highest probability candidate words stored at lexicon data stores 60 that begin with the letters n-a-t. After removing prefix 30 corresponding to the letters n-a, keyboard module 22 may determine that prefixes tion, ture, and tive are suffixes corresponding to selectable elements 32. In this way, the remaining characters associated with each of the candidate words correspond to a partial suffix of each candidate word and each of the character strings that is a partial suffix begins with the selected character (e.g., the letter t).

Keyboard module 22 may cause UI module 20 to present each of the suffixes tion, ture, and tive, as selectable elements 32 at UID 12. In some examples, UI module 20 may output one or more partial suffixes as selectable elements 32 for display at locations of UID 12 that are equally spaced and/or arranged radially outward from a centroid (e.g., a center location) of the particular key associated with the second selection (e.g., gesture 4). In other words, selectable elements 32 may circle or appear around the last selected key of graphical keyboard 16B.

In some examples, UI module 20 may output selectable elements 32 for display at one or more locations of UID 12 that overlap or are on-top-off locations of UID 12 at which keys of graphical keyboard 16B that are adjacent to the last selected key associated with the second selection (e.g., gesture 4) are displayed. In some examples, selectable elements 32 are at least partially transparent so that the overlapping keys below each selectable element 32 are partially visible at UID 12.

In any event, after outputting selectable elements 32 for display, computing device 10 may detect gesture 6 at or near a location of UID 12 at which one of selectable elements 32 is displayed. In other words, responsive to determining a third selection of the at least one character string that is the partial suffix, computing device 10 may output, for display, the candidate word. For example, keyboard module 22 may receive one or more touch events associated with gesture 6 from gesture module 24 and UI module 20. Keyboard module 22 may detect a selection of one of selectable elements 32 nearest to locations of the touch events associated with gesture 6. Due to proximity between locations of touch events associated with gesture 6 and location(s) of selectable element 32A as presented at UID 12, keyboard module 22 may determine that gesture 6 represents a selection being made by a user of computing device 10 of selectable element 32A.

In some examples, gestures 4 and 6 are a single gesture input. In other words, gesture 4 may represent a tap and hold portion of a single gesture and gesture 6 may represent the end of a swipe portion of the single gesture. For instance, after tapping and holding his or her finger at or near a location of UID 12 at which the <T-key> is displayed, the user of computing device 10 may swipe, in one motion, his or her finger or stylus pen from the <T-key> to the location at which UID presents selectable element 32A. In this way, the user may select the <T-key> and selectable element 32A using a single input comprising gestures 4 (e.g., a tap and hold portion of the input) and gesture 6 (e.g., an end of a swipe portion of the input).

Responsive to detecting a selection of selectable element 32A, keyboard module 22 may determine a candidate word that corresponds to the selected one of selectable elements 32. Based on gesture 6, keyboard module 22 may determine that candidate word nation corresponds to selectable element 32A. Keyboard module 22 may cause UI module 20 and UID 12 to include the partial suffix associated with selectable element 32A within edit region 16A of user interface 14. In other words, keyboard module 22 may output the characters associated with suffix 34 to UI module 20 for inclusion within edit region 16A following the characters of prefix 30 such that edit region 16A includes a complete candidate word comprising prefix 30 and suffix 34. UI module 20 may cause UID 12 to output the candidate word nation for display by causing UID 12 to present suffix 34 subsequent to prefix 30 in edit region 16A of user interface 14.

Computing device 10 may present suggested suffixes of one or more candidate words as selectable elements 32 overlaid directly on-top-of keys of graphical keyboard 16B rather than including the suggested suffixes of selectable elements 32 as complete candidate words being presented at some other region of user interface 14 (e.g., a word suggestion bar). Just as computing device 10 can detect input to select one or more of the keys of graphical keyboard 16B, computing device 10 can receive similar input at or near one or more of the keys and keyboard module 22 to determine a selection of a multi-character suffix. A single input detected by computing device 10 can cause keyboard module 22 and UI module 20 of computing device 10 to output a suffix to complete an entry of a candidate word associated with the selected multi-character suffix for display at edit region 16A of user interface 14.

In this way, a user of computing device 10 can type a complete word using graphical keyboard 16B without individually typing or selecting (e.g., with a gesture) a key associated with each individual letter of the word. A user of computing device 10 can type an initial portion of a candidate word (e.g., a prefix) and finish typing the candidate word by selecting a single suffix, presented at or near a last selected key. A computing device such as this may process fewer user inputs as a user provides input to enter text using a graphical keyboard, execute fewer operations in response to receiving fewer inputs, and as a result, consume less electrical power.

In some examples, keyboard module 22 and UI module 20 of computing device 10 may cause UID 12 to present selectable elements 32 within user interface 14 such that each of selectable elements 32 appears “on-top-of” and/or “overlaid onto” the plurality of keys of graphical keyboard 16B when output for display at UID 12. In other words, keyboard module 22 and UI module 20 of computing device 10 may cause UID 12 to present each of selectable elements 32 as co-located and/or layered elements presented over the same position(s) or locations of UID 12 that also present the plurality of keys of graphical keyboard 16B. In some examples, keyboard module 22 and UI module 20 of computing device 10 may cause UID 12 to present selectable elements 32 at least partially or completely obscuring one or more of the plurality of keys of graphical keyboard 16B. In some examples, keyboard module 22 and UI module 20 of computing device 10 may cause UID 12 to present selectable elements 32 at least partially or completely obscuring one or more of the plurality of keys of graphical keyboard 16B that are adjacent to the particular key associated with the selected character that starts each of the suffixes of selectable elements 32.

In some examples, keyboard module 22 and UI module 20 may cause UID 12 to present selectable elements 32 at least proximal to the particular key associated with the selected character that starts each of the suffixes of selectable elements 32. By displaying selectable elements 32 proximal to the particular key associated with the selected character that starts each of the suffixes of selectable elements 32, keyboard module 22 and UI module 20 may cause UID 12 to present each one of selectable elements 32 within a threshold or predefined distance from a centroid location of the particular key (e.g., the threshold or predefined distance may be based on a default value set within the system, such as a defined number of pixels, a distance units, etc.).

In some examples, keyboard module 22 and UI module 20 may cause UID to present selectable elements 32 such that each of selectable elements 32 does not overlap or at least does not partially obscure the particular key associated with the selected character that starts each of the suffixes of selectable elements 32. In some examples, keyboard module 22 and UI module 20 may cause UID to present selectable elements 32 at UID with a shadow effect such that each of selectable elements 32 appears to hover over the plurality of keys of graphical keyboard 16B. In some examples, keyboard module 22 and UI module 20 may cause UID to present selectable elements 32 such that each of selectable elements 32 are arranged radially around the centroid of the particular key associated with the selected character that starts each of the suffixes of selectable elements 32.

In some examples, keyboard module 22 and UI module 20 may cause UID to present selectable elements 32 at a location, position, or region that is not located within a word suggestion bar or word suggestion region that includes one or more candidate words being suggested by graphical keyboard 16B for inclusion in edit region 16A. In other words, rather than include selectable elements 32 in a region of user interface 14 that is specific to candidate words or word suggestions, keyboard module 22 and UI module 20 may cause UID 12 to include selectable elements 32 in locations of graphical keyboard 16B that are associated with the plurality of keys of graphical keyboard 16B. Including selectable elements 32 in location of graphical keyboard 16B that are associated with the plurality of keys of graphical keyboard 16B may increase a speed or efficiency with which a user can select one of selectable elements 32 after first selecting the key associated with the first character or letter of the suffix.

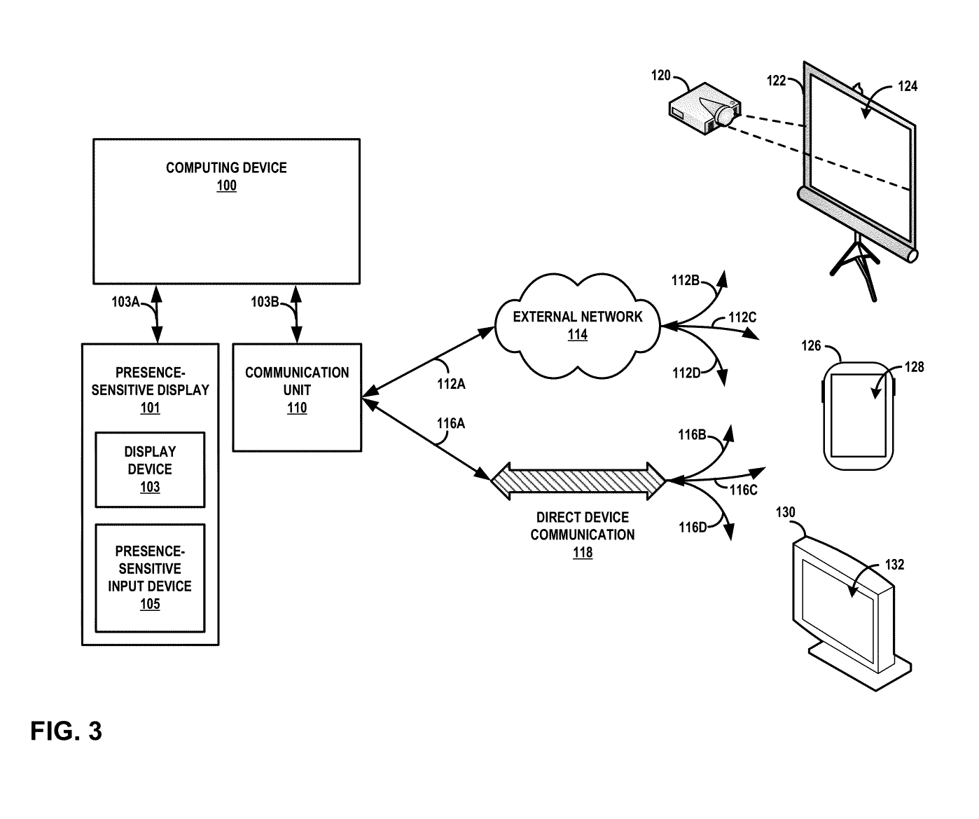

FIG. 3 is a block diagram illustrating an example computing device that outputs graphical content for display at a remote device, in accordance with one or more techniques of the present disclosure. Graphical content, generally, may include any visual information that may be output for display, such as text, images, a group of moving images, etc. The example shown in FIG. 3 includes a computing device 100, presence-sensitive display 101, communication unit 110, projector 120, projector screen 122, tablet device 126, and visual display device 130. Although shown for purposes of example in FIGS. 1 and 2 as a stand-alone computing device 10, a computing device such as computing device 100 and/or computing device 10 may, generally, be any component or system that includes a processor or other suitable computing environment for executing software instructions and, for example, need not include a presence-sensitive display.

As shown in the example of FIG. 3, computing device 100 may be a processor that includes functionality as described with respect to processor 40 in FIG. 2. In such examples, computing device 100 may be operatively coupled to presence-sensitive display 101 by a communication channel 103A, which may be a system bus or other suitable connection. Computing device 100 may also be operatively coupled to communication unit 110, further described below, by a communication channel 103B, which may also be a system bus or other suitable connection. Although shown separately as an example in FIG. 3, computing device 100 may be operatively coupled to presence-sensitive display 101 and communication unit 110 by any number of one or more communication channels.

In other examples, such as illustrated previously by computing devices 10 in FIGS. 1-2, computing device 100 may be a portable or mobile device such as mobile phones (including smart phones), laptop computers, etc. In some examples, computing device 100 may be a desktop computers, tablet computers, smart television platforms, cameras, personal digital assistants (PDAs), servers, mainframes, etc.

Presence-sensitive display 101, like user interface device 12 as shown in FIG. 1, may include display device 103 and presence-sensitive input device 105. Display device 103 may, for example, receive data from computing device 100 and display the graphical content. In some examples, presence-sensitive input device 105 may determine one or more user inputs (e.g., continuous gestures, multi-touch gestures, single-touch gestures, etc.) at presence-sensitive display 101 using capacitive, inductive, and/or optical recognition techniques and send indications of such user input to computing device 100 using communication channel 103A. In some examples, presence-sensitive input device 105 may be physically positioned on top of display device 103 such that, when a user positions an input unit over a graphical element displayed by display device 103, the location at which presence-sensitive input device 105 corresponds to the location of display device 103 at which the graphical element is displayed.

As shown in FIG. 3, computing device 100 may also include and/or be operatively coupled with communication unit 110. Communication unit 110 may include functionality of communication unit 44 as described in FIG. 2. Examples of communication unit 110 may include a network interface card, an Ethernet card, an optical transceiver, a radio frequency transceiver, or any other type of device that can send and receive information. Other examples of such communication units may include Bluetooth, 3G, and Wi-Fi radios, Universal Serial Bus (USB) interfaces, etc. Computing device 100 may also include and/or be operatively coupled with one or more other devices, e.g., input devices, output devices, memory, storage devices, etc. that are not shown in FIG. 3 for purposes of brevity and illustration.

FIG. 3 also illustrates a projector 120 and projector screen 122. Other such examples of projection devices may include electronic whiteboards, holographic display devices, and any other suitable devices for displaying graphical content. Projector 120 and project screen 122 may include one or more communication units that enable the respective devices to communicate with computing device 100. In some examples, the one or more communication units may enable communication between projector 120 and projector screen 122. Projector 120 may receive data from computing device 100 that includes graphical content. Projector 120, in response to receiving the data, may project the graphical content onto projector screen 122. In some examples, projector 120 may determine one or more user inputs (e.g., continuous gestures, multi-touch gestures, single-touch gestures, etc.) at projector screen using optical recognition or other suitable techniques and send indications of such user input using one or more communication units to computing device 100.

Projector screen 122, in some examples, may include a presence-sensitive display 124. Presence-sensitive display 124 may include a subset of functionality or all of the functionality of UI device 4 as described in this disclosure. In some examples, presence-sensitive display 124 may include additional functionality. Projector screen 122 (e.g., an electronic whiteboard), may receive data from computing device 100 and display the graphical content. In some examples, presence-sensitive display 124 may determine one or more user inputs (e.g., continuous gestures, multi-touch gestures, single-touch gestures, etc.) at projector screen 122 using capacitive, inductive, and/or optical recognition techniques and send indications of such user input using one or more communication units to computing device 100.

FIG. 3 also illustrates tablet device 126 and visual display device 130. Tablet device 126 and visual display device 130 may each include computing and connectivity capabilities. Examples of tablet device 126 may include e-reader devices, convertible notebook devices, hybrid slate devices, etc. Examples of visual display device 130 may include televisions, computer monitors, etc. As shown in FIG. 3, tablet device 126 may include a presence-sensitive display 128. Visual display device 130 may include a presence-sensitive display 132. Presence-sensitive displays 128, 132 may include a subset of functionality or all of the functionality of UI device 4 as described in this disclosure. In some examples, presence-sensitive displays 128, 132 may include additional functionality. In any case, presence-sensitive display 132, for example, may receive data from computing device 100 and display the graphical content. In some examples, presence-sensitive display 132 may determine one or more user inputs (e.g., continuous gestures, multi-touch gestures, single-touch gestures, etc.) at projector screen using capacitive, inductive, and/or optical recognition techniques and send indications of such user input using one or more communication units to computing device 100.

As described above, in some examples, computing device 100 may output graphical content for display at presence-sensitive display 101 that is coupled to computing device 100 by a system bus or other suitable communication channel. Computing device 100 may also output graphical content for display at one or more remote devices, such as projector 120, projector screen 122, tablet device 126, and visual display device 130. For instance, computing device 100 may execute one or more instructions to generate and/or modify graphical content in accordance with techniques of the present disclosure. Computing device 100 may output the data that includes the graphical content to a communication unit of computing device 100, such as communication unit 110. Communication unit 110 may send the data to one or more of the remote devices, such as projector 120, projector screen 122, tablet device 126, and/or visual display device 130. In this way, computing device 100 may output the graphical content for display at one or more of the remote devices. In some examples, one or more of the remote devices may output the graphical content at a presence-sensitive display that is included in and/or operatively coupled to the respective remote devices.

In some examples, computing device 100 may not output graphical content at presence-sensitive display 101 that is operatively coupled to computing device 100. In other examples, computing device 100 may output graphical content for display at both a presence-sensitive display 101 that is coupled to computing device 100 by communication channel 103A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 100 and output for display at presence-sensitive display 101 may be different than graphical content display output for display at one or more remote devices.

Computing device 100 may send and receive data using any suitable communication techniques. For example, computing device 100 may be operatively coupled to external network 114 using network link 112A. Each of the remote devices illustrated in FIG. 3 may be operatively coupled to network external network 114 by one of respective network links 112B, 112C, and 112D. External network 114 may include network hubs, network switches, network routers, etc., that are operatively inter-coupled thereby providing for the exchange of information between computing device 100 and the remote devices illustrated in FIG. 3. In some examples, network links 112A-112D may be Ethernet, ATM or other network connections. Such connections may be wireless and/or wired connections.

In some examples, computing device 100 may be operatively coupled to one or more of the remote devices included in FIG. 3 using direct device communication 118. Direct device communication 118 may include communications through which computing device 100 sends and receives data directly with a remote device, using wired or wireless communication. That is, in some examples of direct device communication 118, data sent by computing device 100 may not be forwarded by one or more additional devices before being received at the remote device, and vice-versa. Examples of direct device communication 118 may include Bluetooth, Near-Field Communication, Universal Serial Bus, Wi-Fi, infrared, etc. One or more of the remote devices illustrated in FIG. 3 may be operatively coupled with computing device 100 by communication links 116A-116D. In some examples, communication links 112A-112D may be connections using Bluetooth, Near-Field Communication, Universal Serial Bus, infrared, etc. Such connections may be wireless and/or wired connections.

In accordance with techniques of the disclosure, computing device 100 may be operatively coupled to visual display device 130 using external network 114. Computing device 100 may output a graphical keyboard for display at presence-sensitive display 132. For instance, computing device 100 may send data that includes a representation of the graphical keyboard to communication unit 110. Communication unit 110 may send the data that includes the representation of the graphical keyboard to visual display device 130 using external network 114. Visual display device 130, in response to receiving the data using external network 114, may cause presence-sensitive display 132 to output the graphical keyboard comprising a plurality of keys.

In response to a user performing a first gesture at presence-sensitive display 132 to select a group of keys of the keyboard (e.g., the <N-Key> followed by the <A-key>) visual display device 130 may send an indication of the first gesture to computing device 100 using external network 114. Communication unit 110 of may receive the indication of the first gesture, and send the indication to computing device 100. Subsequent to receiving the indication of the first gesture, and in response to a user performing a subsequent gesture at presence-sensitive display 132 to select a particular key of the keyboard (e.g., the <T-Key>) visual display device 130 may send an indication of the subsequent gesture to computing device 100 using external network 114. Communication unit 110 of may receive the indication of the subsequent gesture, and send the indication to computing device 100.

After receiving the indications of the first and second gestures, computing device 100 may determine, at least one candidate word that includes a partial prefix, the partial prefix being based at least in part on the first selection of the group of keys (e.g., <N-key> and <A-key>) of the one or more of the plurality of keys. In other words, computing device 100 may determine candidate words from a lexicon that include the prefix na and a third letter t. Computing device 100 may determine at least a partial suffix associated with each of the candidate words that start with the letters nat. Computing device 100 may output each of the partial suffixes to visual display device 130 using communication unit 110 and external network 114 to cause visual display device 130 to output each of the partial suffixes, for display at presence-sensitive display 132, at a region of the graphical keyboard that is based on a location of the <T-key>. For example, display device 130 may cause presence-sensitive display 132 to present each of the partial suffixes received over external network 114 as selectable elements positioned radially outward from a centroid location of the <T-key>. The partial suffixes may be spaced evenly around the <T-key>.

In response to a user completing the subsequent gesture, and moving his or her finger in the direction of one of the partial suffixes that is positioned around the <T-key>, visual display device 130 may send an additional indication of the subsequent gesture to computing device 100 using external network 114. Communication unit 110 of may receive the additional indication of the subsequent gesture, and send the indication to computing device 100. Computing device 100 may determine that the additional indication of the same subsequent gesture represents movement at or near a location of the <T-key> in a direction that signifies a selection of one of the partial suffixes arranged around the <T-key>. Computing device 100 may determine that the direction of the subsequent gesture represents a selection of the partial suffix tion and determine that the candidate word nation based on the selection.

Computing device 100 may output data indicative of the candidate word nation to visual display device 130 using communication unit 110 and external network 114 to cause visual display device 130 to output the candidate word, for display at presence-sensitive display 132, at an edit region that is separate and distinct from the graphical keyboard. For example, display device 130 may cause presence-sensitive display 132 to present the letters nation within an edit region of a user interface (e.g., user interface 14 of FIG. 1).

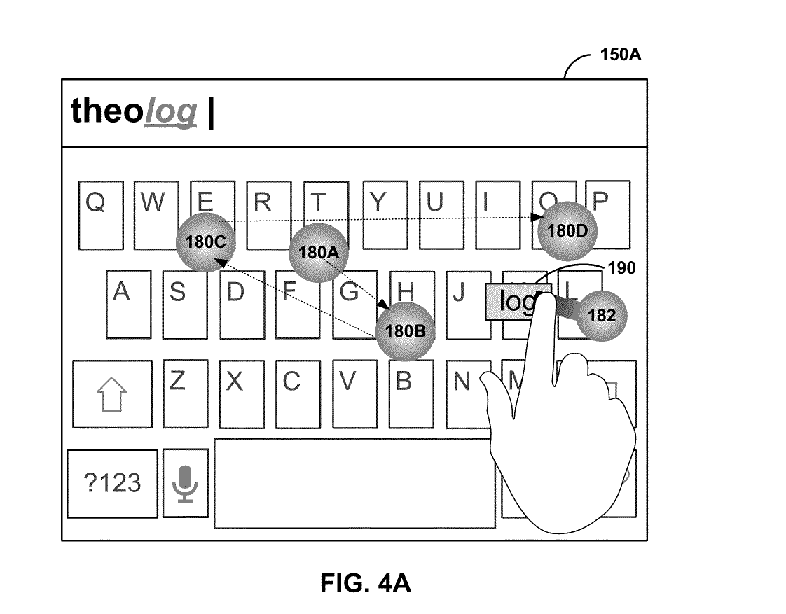

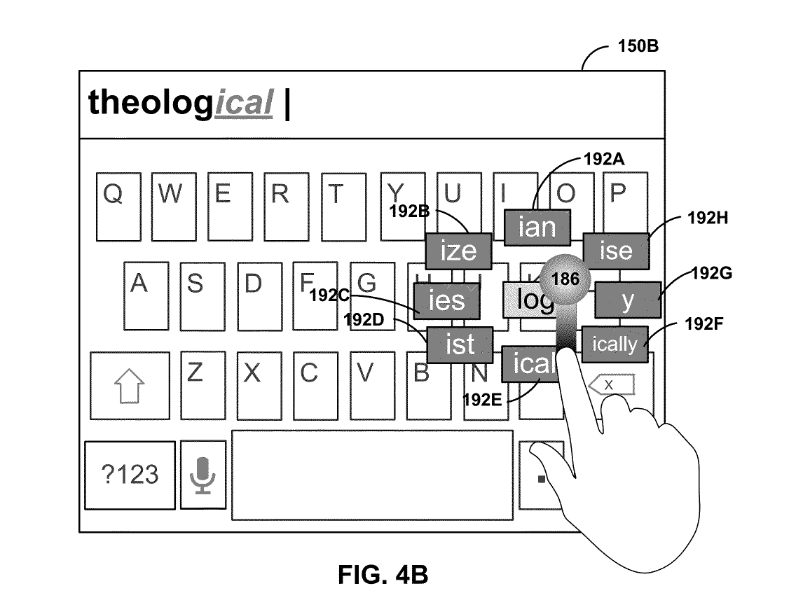

FIGS. 4A and 4B are conceptual diagrams illustrating example graphical user interfaces for presenting one or more partial suffixes of one or more candidate words, in accordance with one or more aspects of the present disclosure. FIGS. 4A and 4B are described below in the context of computing device 10 (described above) from FIG. 1 and FIG. 2.

FIG. 4A illustrates that computing device 10 may output a graphical keyboard comprising a plurality of keys for display and determine both a first selection of one or more of the plurality of keys, and a second selection of a particular key of the plurality of keys. For example, keyboard module 22 may receive a sequence of touch events from gesture module 24 and UI module 20 as a user of computing device 10 interacts with user interface 150A at UID 12. FIG. 4A shows a series of gestures 180A-180D (collectively, “gestures 180”) performed at various locations of the graphical keyboard of user interface 150A to select certain keys. In some examples, gestures 180 represent a single non-tap gesture that traverses multiple keys of the graphical keyboard of user interface 150A. In other examples, gestures 180 represent individual tap gestures for selecting multiple keys of the graphical keyboard of user interface 150A. SM module 28 of keyboard module 22 may determine that gesture 180 represent a selection of the <T-key>, the <H-key>, the <E-key>, and the <O-key> of the graphical keyboard of user interface 150A. Keyboard module 22 may determine that the letters theo correspond to the selection of keys associated with gestures 180 and may cause UI module 20 and UID 12 to present the characters theo at an edit region of user interface 150A.

FIG. 4A further illustrates gesture 182 performed at or near a centroid location of the <L-key> of the graphical keyboard of user interface 150A. Based on a series of touch events associated with gesture 182, keyboard module 22 may determine that gesture 182 represents first, a selection of the <L-key>, and second directional movement away and to the left of the centroid of the <L-key>. Keyboard module 22 may determine the direction of gesture 182 based on information provided by gesture module 24, as described above, or in some examples, keyboard module 22 may determine the direction of gesture 182 by defining a pattern of movement based on the location components of the touch events associated with gesture 182.

Responsive to determining a selection of the <L-key>, keyboard module 22 of computing device 10 may determine at least one candidate word that includes the partial prefix defined by the first selection of keys that also includes the letter 1. In other words, keyboard module 22 may determine one or more candidate words that begin with the letters theo and l. LM module 28 of keyboard module 22 may look-up the characters theol from within lexicon data stores 60 and identify one or more candidate words that begin with the letters theol and have a probability (e.g., indicating a frequency of use of in a language context) that satisfies a threshold for causing keyboard module 22 to cause UI module 20 and UID 12 to output a selectable element associated with each of the candidate words (e.g., selectable element 190) for display at UID 12. For example, keyboard module 22 may identify the candidate words theologian, theologize, theologies, theologist, theological, theologically, theology, and theologise as the several candidate words that begin with the letters theol and have a probability that satisfies the threshold.

FIG. 4A further shows that keyboard module 22 may cause UI module 20 and UID 12 to output, for display at a region of the graphical keyboard of user interface 150B that is based on a location of the <L-key>, at least one character string that is a partial suffix of the at least one candidate word that comprises the partial prefix and the partial suffix. In other words, keyboard module 22 may output data indicative of the characters log to UI module 20 along with instructions for presenting the characters log, as selectable element 190, at a location that is a predefined distance away from the centroid of the <L-key>.

Responsive to determining a third selection of the selectable element 190 associated with the character string log, keyboard module 22 may cause UI module 20 to output, based at least in part on the selection of selectable element 190 and for display, one or more subsequent character strings that are partial suffixes of previously identified candidate words. For example, as described above, keyboard module 22 may determine the direction of gesture 182 based on information provided by gesture module 24, or in some examples, by defining a pattern of movement based on the location components of the touch events associated with gesture 182. In any case, keyboard module 22 may determine that the direction of gesture 182 satisfies a criterion for indicating a selection of selectable element 190, and the corresponding suffix log. In other words, keyboard module 22 may determine that a gesture, such as gesture 182, that begins at or near a centroid of the <L-key>, after keyboard module 22 detects a selection of the <T-key>, the <H-key>, the <E-key>, and the <O-key> of the graphical keyboard of user interface 150A, indicates a further selection of the suffix log.

Keyboard module 22 may cause UI module 20 and UID 12 to include the characters log within the edit region of user interface 150A in response to detecting the selection of the suffix log. In other words, keyboard module 22 may determine a direction of gesture 182 (e.g., a gesture detected at the region of the graphical keyboard at which the particular <T-key> is displayed), and may further determine, based at least in part on the direction of gesture 182, a selection of the at least one character string that is the partial suffix (e.g., the suffix log).

FIG. 4B shows that, subsequent to determining the selection of the suffix log that keyboard module 22 may cause UI module 20 and UID 12 to output selectable elements 192A-192H (collectively, “selectable elements 192”) for display at UID 12. Each of selectable elements 192 corresponds to a different one of the candidate words identified previously that comprises the prefix theo and the suffix log. In other words, FIG. 4B illustrates an example of presenting additional suffixes for inputting additional multi-character suffixes for completing the entry of a candidate word using a graphical keyboard, such as the graphical keyboard of user interfaces 150A and 150B.

FIG. 4B shows gesture 186 originating at a location of the selectable element associated with the suffix log after UID 12 outputs selectable elements 192 for display at UID 12. Keyboard module 22 may determine that the touch events associated with gesture 186 represent a selection of the suffix ical. For instance, keyboard module 22 may determine that the direction of gesture 186 corresponds to a mostly downward motion indicating a selection of the one of selectable elements 192 that is beneath the suffix log. Responsive to determining a selection of the suffix ical, keyboard module 22 may cause UI module 20 and UID 12 to complete the output of the candidate word theological for display (e.g., within an edit region of user interface 150B).

In some examples, the partial prefix is a substring of characters that do not exclusively represent the at least one candidate word. In other words, the keyboard module 22 may determine a partial prefix associated with a first selection of keys (e.g., theo) that alone does not represent any of the determined candidate words contained with lexicon data stores 60. Said differently, although the partial prefix associated with the first selection of keys may be included in one or more candidate words, each candidate word may include additional characters.

In some examples, the partial suffix is a substring of characters that does not alone represent the at least one candidate word. In other words, the keyboard module 22 may determine a partial suffix based on a first selection of keys (e.g., theo) and a second selection of a particular key (e.g., the <T-key> that alone does not represent any of the determined candidate words contained with lexicon data stores 60. Said differently, although the partial suffix determined based on the first selection of keys and the second selection of the particular key may be included in one or more candidate words, each candidate word may include additional characters before the characters associated with the suffix and/or after the characters associated with the suffix.

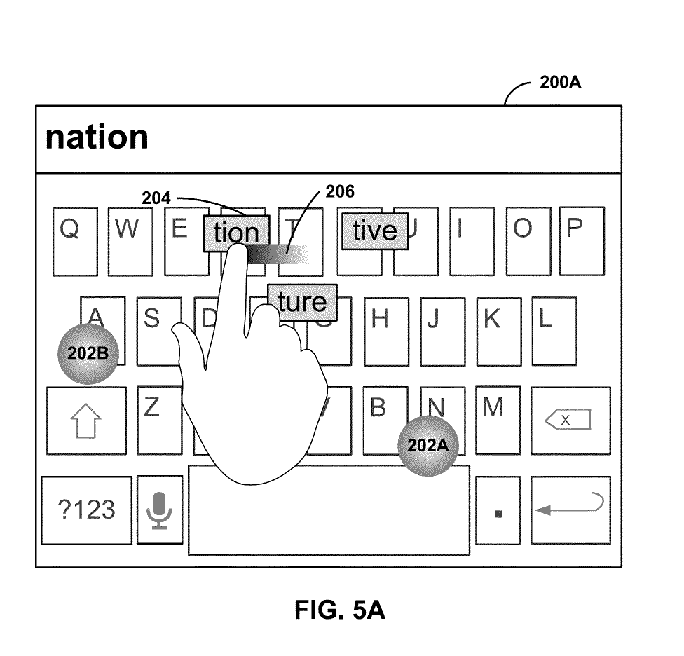

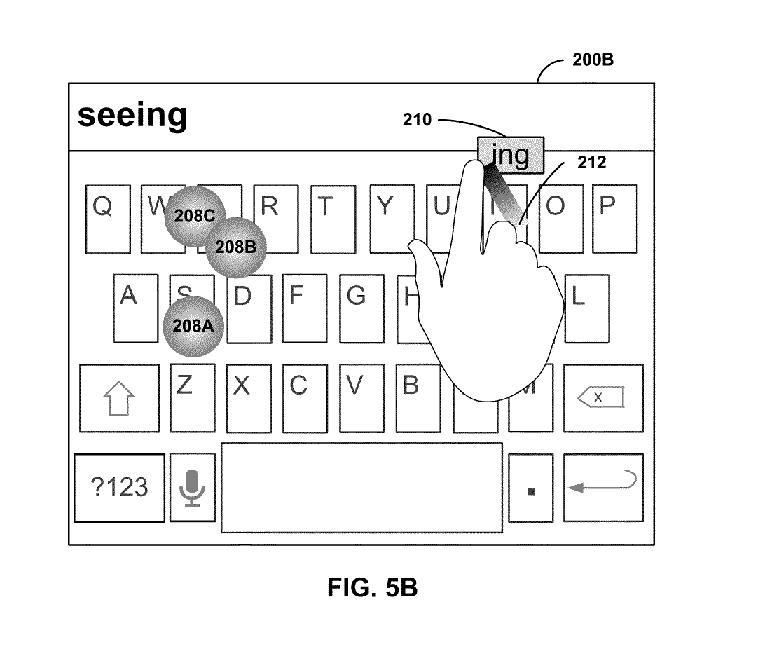

FIGS. 5A and 5B are conceptual diagrams illustrating example graphical user interfaces for presenting one or more partial suffixes of one or more candidate words, in accordance with one or more aspects of the present disclosure. FIGS. 5A and 5B are described below in the context of computing device 10 (described above) from FIG. 1 and FIG. 2.

A computing device according to the techniques of this disclosure may improve the efficiency of entering text using a graphical keyboard presented using a touchscreen or other presence-sensitive screen technology. To enter a word on some other graphical keyboards, users may sequentially type the corresponding letters of the word. Each tap or swipe gesture action may generate one letter. A user of a computing device according to the techniques of this disclosure may however enter multiple letters with fewer inputs, which may improve the typing speed. Some languages (e.g., English, French, etc.) have regularities. These regularities can be exploited to improve text entry speed. A computing device according to the techniques of this disclosure may take advantage of or exploit the regularity of a written language that some letter combinations appear more frequently than others. For example, in the English language, the letter combinations ing, tion, nion, ment, and ness, etc. occur more frequently than other letter combinations. The computing device according to the techniques of this disclosure associates each of these frequent letter combinations with the corresponding starting letter (i.e., the first letter of the combinations) on a graphical keyboard. A user can quickly enter one of these frequent letter combinations by sliding his or her input (e.g., finger or stylus) in a certain direction from the centroid of the corresponding letter.

For example, FIG. 5A shows the input of the word nation. Computing device 10 may cause UID 12 to present user interface 200A which includes an edit region and a plurality of keys of a graphical keyboard. The user of computing device 10 may provide inputs 202A and 202B as first selections of the letters n and a. The user of computing device 10 may begin to provide input 206 at the <T-key> of the graphical keyboard. Because the common letter combination tion is associated to the character associated with the <T-key> (e.g., the letter t), and because computing device 10 determines a direction of input 206 corresponds to a right-to-left direction, computing device 10 may determine that the user has selected selectable element 204 representing a combination of letters tion. In other words, computing device 10 may allow the user to enter tion by sliding his or her finger from starting at the <T-key> to the left direction. A user of computing device 10 can cause computing device 10 to enter the word nation by three actions including: tapping of the <N-key>, tapping of the <A-key>, and sliding from the <T-key> to the left direction. Note FIG. 5B shows other letter combinations tive and tune associated with other selectable elements that are associated with t, in different directions.

FIG. 5B shows the input of the word seeing. Computing device 10 may cause UID 12 to present user interface 200B which includes an edit region and a plurality of keys of a graphical keyboard. The user of computing device 10 may provide inputs 208A, 208B, and 208C as first selections of the letters s, e, and e. The user of computing device 10 may begin to provide input 212 at the <I-key> of the graphical keyboard. Because the common letter combination ing is associated to the character associated with the <I-key> (e.g., the letter i), and because computing device 10 determines a direction of input 212 corresponds to the up direction, computing device 10 may determine that the user has selected selectable element 210 representing a combination of letters ing. In other words, computing device 10 may allow the user to enter ing by sliding his or her finger from starting at the <I-key> to the up direction. A user of computing device 10 can cause computing device 10 to enter the word seeing by three actions including: tapping of the <S-key>, double tapping of the <E-key>, and sliding from the <I-key> to the up direction.

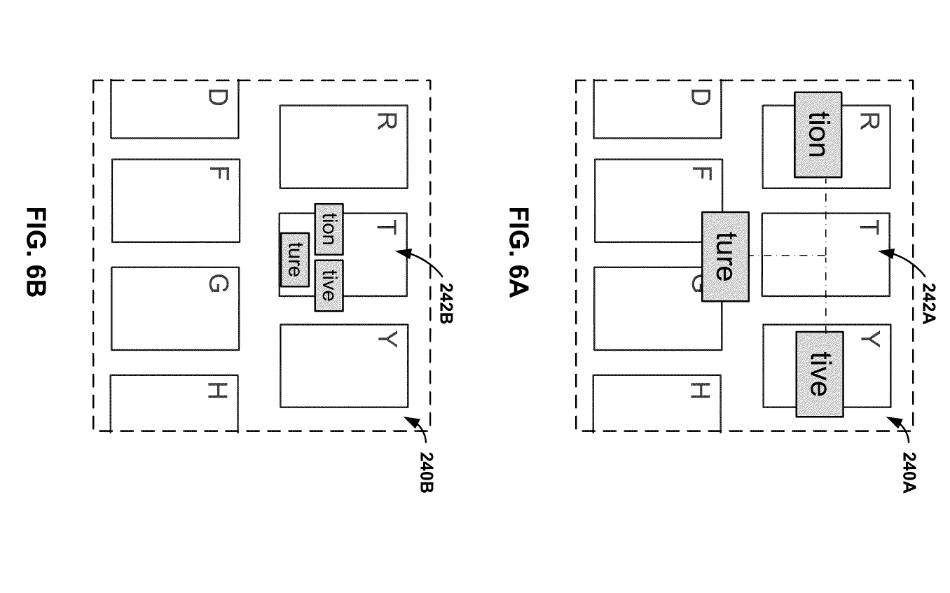

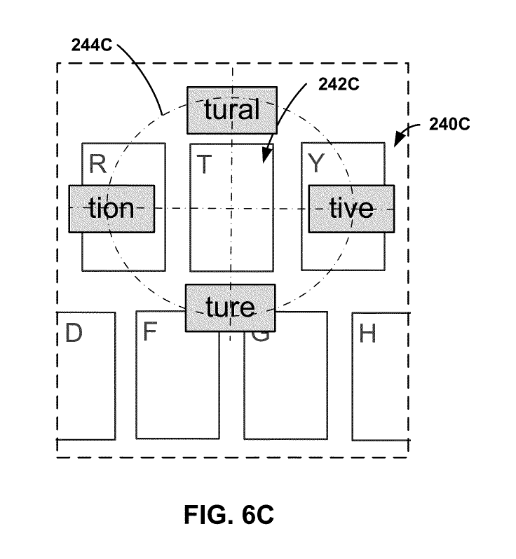

FIGS. 6A through 6C are conceptual diagrams illustrating additional example graphical user interfaces for presenting one or more partial suffixes of one or more candidate words, in accordance with one or more aspects of the present disclosure. FIG. 6A through 6C are described below within the context of computing device 10 of FIG. 1 and FIG. 2. FIGS. 6A through 6C each illustrate a region of a graphical keyboard, such as graphical keyboard 16B shown in FIG. 1, and a plurality of selectable elements associated with partial suffixes being output for display by UID 12, in various ways and arrangements and in accordance with the techniques described in this disclosure.

FIG. 6A shows that keyboard module 22 of computing device 10 may cause UI module 20 and UID 12 to output, for display at region 240A of a graphical keyboard that is based on a location of key 242A, at least one character string that is a partial suffix of the at least one candidate word. Said differently, FIG. 6A illustrates keyboard module 22 causing UID 12 to present partial suffixes tion, ture, and tive, within region 240A.

In some examples, the location of key 242A may be a first location of UID 12, and the character strings that are partial suffixes may be output for display at a second location of UID 12 that is different from the first location. In other words, keyboard module 22 may cause UI module 20 and UID 12 to present partial suffixes tion, ture, and tive and key 242A, all within region 240A, however keyboard module 22 may cause UI module 20 and UID 12 to present each of the partial suffixes tion, ture, and tive at different locations of UID 12 than the location of key 242A.

In some examples, the character string are output for display such that the character strings overlap a portion of at least one of the plurality of keys adjacent to the particular key. In other words, the keys that are adjacent to key 242A are the <R-key>, the <Y-key>, the <F-key>, and the <G-key>. FIG. 6A shows that keyboard module 22 may cause UI module 20 and UID 12 to present each of the partial suffixes tion, ture, and tive at different locations of UID 12 that overlap each of the adjacent keys.

FIG. 6B shows that keyboard module 22 of computing device 10 may cause UI module 20 and UID 12 to output, for display at region 240B of a graphical keyboard that is based on a location of key 242B, at least one character string that is a partial suffix of the at least one candidate word. Said differently, FIG. 6B illustrates keyboard module 22 causing UID 12 to present partial suffixes tion, ture, and tive, within region 240B.

In some examples, the location of key 242B may be a first location of UID 12, and the character strings that are partial suffixes may be output for display at a second location of UID 12 that is the same as the first location. In other words, keyboard module 22 may cause UI module 20 and UID 12 to present partial suffixes tion, ture, and tive and key 242B, all within region 240B, and all at or near the same location of key 242B.

FIG. 6C shows that keyboard module 22 of computing device 10 may cause UI module 20 and UID 12 to output, for display at region 240C of a graphical keyboard that is based on a location of key 242C, at least one character string that is a partial suffix of the at least one candidate word. Said differently, FIG. 6C illustrates keyboard module 22 causing UID 12 to present partial suffixes tion, ture, tive, and tural within region 240C.

In some examples, the character strings (e.g., the partial suffixes) may be output for display such that each of the character strings is arranged radially outward from a centroid location of key 242C and at least one of the character strings overlaps at least a portion of one or more adjacent keys to the particular key. In other words, keyboard module 22 may cause UI module 20 and UID 12 to present suffixes tion, ture, tive, and tural at locations which are a threshold distance away from a centroid location of key 242C and/or positioned radially around key 242C (e.g., FIG. 6C shows a conceptual line indicating circle 244C to illustrate the radial arrangement of suffixes around a particular key).

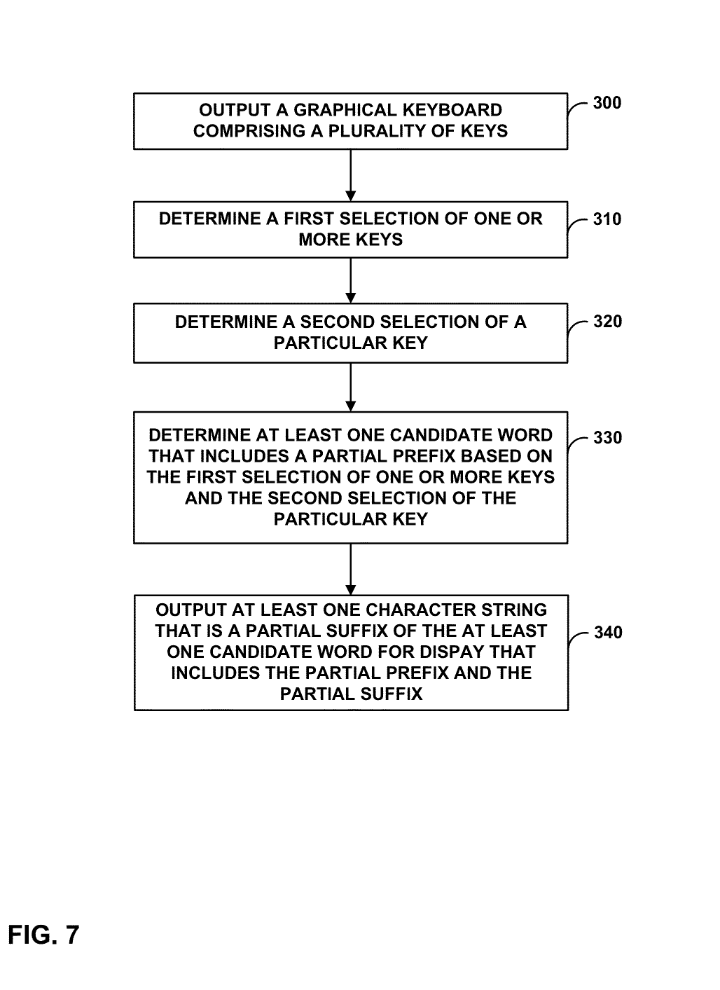

FIG. 7 is a flowchart illustrating an example operation of the computing device, in accordance with one or more aspects of the present disclosure. The process of FIG. 7 may be performed by one or more processors of a computing device, such as computing device 10 illustrated in FIG. 1 and FIG. 2. For purposes of illustration only, FIG. 7 is described below within the context of computing devices 10 of FIG. 1 and FIG. 2.

FIG. 7 illustrates that computing device 10 may output a graphical keyboard comprising a plurality of keys (300). For example, UI module 20 of computing device 10 may cause UID 12 to present graphical user interface 14 including edit region 16A and graphical keyboard 16B.

Computing device 10 may determine a first selection of one or more keys (310). For example, a user of computing device 10 may wish to enter the character string nation. Computing device 10 may receive an indication of gestures 2 as the user taps at or near locations of UID 12 at which the <N-key> and the <A-key> are displayed. SM module 26 of keyboard module 22 may determine, based on a sequence of touch events associated with gestures 2, a first selection of the <N-key> and <A-key>. Keyboard module 22 may cause UI module 20 to include the letters associated with the first selection (e.g., na) as characters of text within edit region 16A of user interface 14.

Computing device 10 may determine a second selection of a particular key (320). For example, computing device 10 may receive an indication of gestures 4 as the user taps and holds at or near locations of UID 12 at which the <T-key> is displayed. SM module 26 of keyboard module 22 may determine, based on a sequence of touch events associated with gestures 4, a second selection of the <T-key>.

To improve a typing speed or efficiency associated with inputting text using computing device 10, computing device 10 may determine at least one candidate word that includes a partial prefix based on the first selection of one or more keys and the second selection of the particular key (330). For example, LM module 28 of keyboard module 22 may determine one or more candidate words based on the first selection of the <N-key> and the <A-key> and the second selection of the <T-key>. LM module 28 may perform a lookup within lexicon data stores 60 of one or more candidate words that begin with the prefix na and end with a suffix that starts with the letter t. Keyboard module 22 may narrow down the one or more candidate words identified from within lexicon data stores 60 to identify only the one or more candidate words that have a high frequency of use in the English language. In other words, keyboard module 22 may determine a probability associated with each of the candidate words that begin with the letters nat and determine whether the probability of each satisfies a threshold (e.g., fifty percent).

Computing device 10 may output at least one character string that is a partial suffix of the at least one candidate word for display that includes the partial prefix and the partial suffix (340). For example, keyboard module 22 may isolate a partial suffix associated with the each of the high probability identified candidate words that begins with the letter t by removing the prefix comprising the letters na from each candidate word. Keyboard module 22 may determine that the remaining characters of each candidate word, after removing the initial letters na, correspond to a partial suffix for each. Keyboard module 22 may output the partial suffix for each candidate word to UI module 20 for inclusion into user interface 14 as selectable elements 32 that UID 12 outputs for display at or near the <T-key>. After outputting selectable elements 32 for display, computing device 10 may receive an indication of gesture 6 as the user slides his or her finger from the <T-key> to the left and at or near selectable element 32A.

In some examples, responsive to determining a third selection of the at least one character string that is the partial suffix, computing device 10 may output, for display, the candidate word. For example, keyboard module 22 may receive information from gesture module 24 and UI module 20 indicating the receipt by computing device 10 of gesture 6. In some examples, gestures 4 and 6 represent a single swipe gesture that originates from a particular key and ends at one of selectable elements 32. In other words, computing device 10 may receive an indication of a single gesture (including gestures 4 and 6 shown in FIG. 1) at the region of the graphical keyboard at which the particular key (e.g., the <T-key) is output for display by UID 12. The second selection (e.g., the selection of the <T-key>) and the third selection (e.g., the selection of selectable element 32A) may each be determined by computing device 10 based on the single gesture at the region of the graphical keyboard.

In any case, whether a single gesture comprising gestures 4 and 6 is provided to select the <T-key> and selectable element 32A or if two individual gestures 4 and 6 are provided to select the <T-key> and selectable element 32A, keyboard module 22 may determine a third selection of selectable element 32A based on gestures 4 and 6 and may output the suffix tion to UI module 20 with instructions for including the characters tion within edit region 16A of user interface 14. UI module 20 may cause UID 12 to update the presentation of user interface 14 to include the letters tion after the prefix na such that the candidate word nation is output for display at UID 12.

Clause 1. A method, comprising: determining, by a first computing device and based on contextual information associated with a user of the first computing device, a location of the first user at a particular time; determining, by the first computing device and based on contextual information associated a second user of a second computing device, that the second user is located within a threshold distance of the location of the first user at the particular time; identifying, by the first computing device and based on the contextual information associated with the first and second users, at least one data file that is predicted to be accessed by the first user using the first computing device at the particular time; and responsive to identifying the at least one data file, outputting, by the first computing device, for display, an graphical indication of the at least one data file that is predicted to be accessed by the first user using the first computing device at the particular time.

Clause 2. The method of clause 1, further comprising: determining, by the computing device, a direction of a gesture detected at the region of the graphical keyboard; and determining, by the computing device, based at least in part on the direction of the gesture, a third selection of the at least one character string that is the partial suffix.

Clause 3. The method of any of clauses 1-2, further comprising: responsive to determining a third selection of the at least one character string that is the partial suffix, outputting, by the computing device and for display, the candidate word.

Clause 4. The method of clause 3, further comprising: receiving, by the computing device, an indication of a single gesture at the region of the graphical keyboard, wherein the second selection and the third selection are each determined based on the single gesture at the region of the graphical keyboard.

Clause 5. The method of any of clauses 1-4, wherein the particular key corresponds to a selected character, wherein each of the at least one character strings that is a partial suffix begins with the selected character.

Clause 6. The method of any of clauses 1-5, wherein the location of the particular key is a first location, wherein the at least one character string that is a partial suffix is output for display at a second location that is different from the first location.

Clause 7. The method of any of clauses 1-6, wherein the location of the particular key is a first location, wherein the at least one character string that is a partial suffix is output for display at a second location that is the same as the first location.

Clause 8. The method of any of clauses 1-7, wherein the at least one character string is output for display such that the at least one character string overlaps a portion of at least one of the plurality of keys adjacent to the particular key.

Clause 9. The method of any of clauses 1-8, wherein the at least one character string is output for display at a threshold distance away from a centroid location of the particular key.

Clause 10. The method of any of clauses 1-9, wherein the at least one character string comprises a plurality of character strings that are output for display such that each of the plurality of character strings is arranged radially outward from a centroid location of the particular key and at least one of the plurality of character strings overlaps at least a portion of one or more adjacent keys to the particular key.

Clause 11. The method of any of clauses 1-10, wherein at least one of (1) the partial prefix is a substring of characters that do not exclusively represent the at least one candidate word or (2) the partial suffix is a substring of characters that does not alone represent the at least one candidate word.

Clause 12. The method of any of clauses 1-11, further comprising: determining, by the computing device, a probability associated with the at least one candidate word that includes the partial prefix, the probability indicating a frequency of use of the at least one candidate word in a language context; and responsive to determining that the probability of associated with the at least one candidate word satisfies a threshold, outputting, by the computing device and for display, the at least one character string that is a partial suffix of the at least one candidate word.

Clause 13. The method of any of clauses 1-12, wherein the at least one character string is a first character string that is a first partial suffix of the at least one candidate word, the method further comprising: responsive to determining a third selection of the first character string, outputting, by the computing device, based at least in part on the third selection and for display, a second character string that is a second partial suffix of the at least one candidate word, wherein the at least one candidate word comprises the partial prefix, the first partial suffix, and the second partial suffix; and responsive to determining a fourth selection of the second character string that is the second partial suffix, outputting, by the computing device and for display, the candidate word.

Clause 14. A computing device comprising: at least one processor; and at least one module operable by the at least one processor to: output, for display, a graphical keyboard comprising a plurality of keys; determine a first selection of one or more of the plurality of keys; responsive to determining a second selection of a particular key of the plurality of keys, determine, based at least in part on the first selection of one or more of the plurality of keys and the second selection of the particular key, at least one candidate word that includes a partial prefix, the partial prefix being based at least in part on the first selection of the one or more of the plurality of keys; and output, for display at a region of the graphical keyboard that is based on a location of the particular key, at least one character string that is a partial suffix of the at least one candidate word, wherein the at least one candidate word comprises the partial prefix and the partial suffix.

Clause 15. The computing device of clause 14, wherein the at least one module is further operable by the at least one processor to: determine a direction of a gesture detected at the region of the graphical keyboard; and determine, based at least in part on the direction of the gesture, a third selection of the at least one character string that is the partial suffix.

Clause 16. The computing device of any of clauses 14-15, wherein the at least one module is further operable by the at least one processor to: responsive to determining a third selection of the at least one character string that is the partial suffix, output, for display, the candidate word.

Clause 17. The computing device of any of clauses 14-16, wherein the location of the particular key is a first location, wherein the at least one character string that is a partial suffix is output for display at a second location that is different from the first location.

Clause 18. The computing device of any of clauses 14-17, wherein the region of the graphical keyboard at which the at least one character string is output for display such that the at least one character string overlaps a portion of at least one of the plurality of keys adjacent to the particular key.

Clause 19. The computing device of any of clauses 14-18, wherein the at least one character string comprises a plurality of character strings that are output for display such that each of the plurality of character strings is arranged radially outward from a centroid location of the particular key and each of the plurality of character strings overlaps at least a portion of one or more adjacent keys to the particular key.

Clause 20. A computer-readable storage medium comprising instructions that, when executed, configure one or more processors of a computing system to: output, for display, a graphical keyboard comprising a plurality of keys; determine a first selection of one or more of the plurality of keys; responsive to determining a second selection of a particular key of the plurality of keys, determine, based at least in part on the first selection of one or more of the plurality of keys and the second selection of the particular key, at least one candidate word that includes a partial prefix, the partial prefix being based at least in part on the first selection of the one or more of the plurality of keys; and output, for display at a region of the graphical keyboard that is based on a location of the particular key, at least one character string that is a partial suffix of the at least one candidate word, wherein the at least one candidate word comprises the partial prefix and the partial suffix.

Clause 21. The computer-readable storage medium of clause 20, wherein the computer-readable storage medium is encoded with further instructions that, when executed, cause the at least one processor of the computing device to: responsive to determining a third selection of the at least one character string that is the partial suffix, output, for display, the candidate word.

Clause 22. The computer-readable storage medium of any of clauses 21-22, wherein the at least one character string comprises a plurality of character strings that are output for display such that each of the plurality of character strings is arranged radially outward from a centroid location of the particular key and at least one of the plurality of character strings overlaps at least a portion of one or more adjacent keys to the particular key.

Clause 23. A computing device comprising means for performing any of the methods of clauses 1-13.

Clause 24. A computer-readable storage medium encoded with instructions for causing one or more programmable processors to perform any of the methods recited by clauses 1-13.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
outputting, by a computing device and for display, a graphical keyboard comprising a plurality of individual character keys;
receiving, by the computing device, an indication of a single gesture at the region of the graphical keyboard;
determining, by the computing device, based on the single gesture, a first selection of one or more of the plurality of individual character keys;
determining, by the computing device, based on the first selection of the one or more of the plurality of individual character keys, a partial prefix of one or more candidate words;
determining, by the computing device, based on the single gesture, a second selection of a particular individual character key of the plurality of individual character keys;
responsive to determining the second selection of a particular individual character key of the plurality of individual character keys:
determining, by the computing device, based at least in part on the first selection of the one or more of the plurality of individual character keys and the second selection of the particular individual character key, at least one candidate word from the one or more candidate words, the at least one candidate word including:
the partial prefix,
a first partial suffix that includes, at a beginning position of the first partial suffix, a sole character based on the particular individual character key, and
at least one second partial suffix, the at least one second partial suffix being exclusive from the partial prefix and the first partial suffix; and
outputting, by the computing device, for display at a region of the graphical keyboard that is based on a location of the particular individual character key, a first character string that is the first partial suffix of the at least one candidate word;
determining, by the computing device, based on the single gesture, a third selection of the first character string that is the first partial suffix of the at least one candidate word; and
responsive to determining the third selection of the first character string that is the first partial suffix of the at least one candidate word, outputting, by the computing device and for display, a second character string that is the second partial suffix.

2. The method of claim 1, further comprising:
determining, by the computing device, a direction of the single gesture detected at the region of the graphical keyboard; and
determining, by the computing device, based at least in part on the direction of the single gesture, the third selection of the first character string that is the first partial suffix of the at least one candidate word.

3-5. (canceled)

6. The method of claim 1, wherein the location of the particular individual character key is a first location, wherein the first character string that is the first partial suffix of the at least one candidate word is output for display at a second location that is the same as the first location.

7. The method of claim 1, wherein the first character string is output for display such that the first character string overlaps a portion of at least one of the plurality of individual character keys adjacent to the particular key.

8. The method of claim 1, wherein the first character string comprises a plurality of character strings that are output for display such that each of the plurality of character strings is arranged radially outward from a centroid location of the particular individual character key and at least one of the plurality of character strings overlaps at least a portion of one or more adjacent individual character keys to the particular individual character key.

9. The method of claim 1, wherein at least one of (1) the partial prefix is a substring of characters that do not exclusively represent the at least one candidate word or (2) the first partial suffix is a substring of characters that does not alone represent the at least one candidate word.

10. The method of claim 1, further comprising:
determining, by the computing device, a probability associated with the at least one candidate word that includes the partial prefix, the probability indicating a frequency of use of the at least one candidate word in a language context;
responsive to determining that the probability associated with the at least one candidate word satisfies a threshold:
outputting, by the computing device and for display, the first character string that is the first partial suffix of the at least one candidate word; and
refraining from outputting, by the computing device and for display, character strings that are any of the one or more candidate words.

11. The method of claim 1, further comprising:
responsive to determining, based on the single gesture, a fourth selection of the second character string that is the second partial suffix, outputting, by the computing device and for display, the at least one candidate word.

12. A computing device comprising:
at least one processor; and
at least one module operable by the at least one processor to:
output, for display, a graphical keyboard comprising a plurality of individual character keys;
receive an indication of a single gesture at the region of the graphical keyboard;
determine, based on the single gesture, a first selection of one or more of the plurality of individual character keys;
determine, based on the first selection of the one or more of the plurality of individual character keys, a partial prefix of one or more candidate words;
determine, based on the single gesture, a second selection of a particular individual character key of the plurality of individual character keys;
responsive to determining the second selection of a particular individual character key of the plurality of individual character keys:
determine, based at least in part on the first selection of the one or more of the plurality of individual character keys and the second selection of the particular individual character key, from the one or more candidate words, the at least one candidate word including:
the partial prefix,
a first partial suffix that includes, at a position of the first partial suffix, a sole character based on the particular individual character key, and
at least one second partial suffix, the at least one second partial suffix being exclusive from the partial prefix and the first partial suffix;
refrain from outputting, for display, character strings that are any of the one or more candidate words; and
output, for display at a region of the graphical keyboard that is based on a location of the particular individual character key, a first character string that is the first partial suffix of the at least one candidate word;
determine, based on the single gesture, a third selection of the first character string that is the first partial suffix of the at least one candidate word; and
responsive to determining the third selection of the first character string that is the first partial suffix of the at least one candidate word, output, for display, a second character string that is the second partial suffix.

13. The computing device of claim 12, wherein the at least one module is further operable by the at least one processor to:
determine a direction of the single gesture detected at the region of the graphical keyboard; and
determine, based at least in part on the direction of the single gesture, the third selection of the first character string that is the first partial suffix of the at least one candidate word.

14. (canceled)

15. The computing device of claim 12, wherein the location of the particular individual character key is a first location, wherein the first character string that is the first partial suffix of the at least one candidate word is output for display at a second location that is different from the first location.

16. The computing device of claim 12, wherein the region of the graphical keyboard at which the first character string is output for display such that the first character string overlaps a portion of at least one of the plurality of individual character keys adjacent to the particular individual character key.

17. The computing device of claim 12, wherein the first character string comprises a plurality of character strings that are output for display such that each of the plurality of character strings is arranged radially outward from a centroid location of the particular individual character key and each of the plurality of character strings overlaps at least a portion of one or more adjacent individual character keys to the particular individual character key.

18. A computer-readable storage medium encoded with instructions that, when executed, cause at least one processor of a computing device to:
output, for display, a graphical keyboard comprising a plurality of individual character keys;
determine, based on a first selection of one or more of the plurality of individual character keys, a partial prefix of one or more candidate words;
responsive to determining a second selection of a particular individual character key of the plurality of individual character keys:
determine, based at least in part on the first selection of the one or more of the plurality of individual character keys and the second selection of the particular individual character key, from the one or more candidate words, the at least one candidate word including:
the partial prefix,
a first partial suffix that includes, at a position of the first partial suffix, a sole character based on the particular individual character key, and
at least one second partial suffix, the at least one second partial suffix being exclusive from the partial prefix and the first partial suffix;
refrain from outputting, for display, character strings that are any of the one or more candidate words; and
output, for display at a region of the graphical keyboard that is based on a location of the particular individual character key, a first character string that is the first partial suffix of the at least one candidate word;
responsive to determining a third selection of the first character string that is the first partial suffix of the at least one candidate word, output, for display, a second character string that is the second partial suffix of the at least one candidate word, wherein the first and second character strings each comprise a respective plurality of character strings that are output for display such that each of the respective plurality of character strings is arranged radially outward from a centroid location of the particular individual character key and at least one of each of the respective plurality of character strings overlaps at least a portion of one or more adjacent individual character keys to the particular individual character key.

19-21. (canceled)

22. The method of claim 1, further comprising:
while outputting the first character string that is the first partial suffix of the at least one candidate word, refraining from outputting, by the computing device, for display, character strings that are any of the one or more candidate words.
